(19) United States
(12) Patent Application Publication
(10) Pub. No.: US 2025/0245885 A1
(43) Pub. Date: Jul. 31, 2025

(54) SYSTEMS AND METHODS FOR GENERATING AND DISTRIBUTING INSTANT AVATAR STICKERS

(71) Applicant: Meta Platforms Technologies, LLC, Menlo Park, CA (US)

(72) Inventors: Junian Ioffe, Brooklyn, NY (US); Neeraj Dinesh Khurana, New York, NY (US); Igor Lifar, New York, NY (US); Andrea Limjoco, London (GB); Adwoa Katherine Nuakoh Baah, Brooklyn, NY (US); Jamie Robert Barnes, Wembely (GB); Jye Sawtell-Rickson, Hitchin (GB); Xin Hu, Issaquah, WA (US)

(21) Appl. No.: 18/426,309

(22) Filed: Jan. 29, 2024

(51) Int. Cl. G06T 11/60; G06F 40/30

(52) U.S. Cl. CPC G06T 11/60; G06F 40/30; G06T 2200/24

(57) ABSTRACT

A system and method of generating visual representations of user intent are described. An example method includes, in response to a text field presented at a display communicatively coupled with the computing device, determining, based on textual data presented at the display communicatively coupled with the computing device, a user intent in responding to a portion of the textual data and generating one or more visual representations of the user intent. Each visual representation includes a representation of a user, and an expression of the user intent performed by the representation of the user. The method further includes presenting the one or more visual representations of the user intent via the display communicatively coupled with the computing device and, in response to user selection of a visual representation of the one or more visual representations, causing display of the visual representation in the text field.

### TECHNICAL FIELD

The systems and methods disclosed herein relate generally to generating visual representations of a user, including, but not limited to, techniques for determining user intent based on user input and generating personalized visual representations of the user intent, which are compositions of assets generated and determined to contextualize the user intent.

### BACKGROUND

Users frequently interact through electronic messages. Such messaging systems restrict a user's ability to be expressive and creative by limiting most communications to words. However, it is not always possible for users to express themselves using words. Existing solutions rely on providing pre-existing images or well-known user interface elements, such as emoticons and emojis, to assist the user in expressing their emotions or showing their creativity. Such solutions require a large library of previously created image files and user interface elements that do not include an instantly personalized image or user interface element based on the user's input for capturing a particular emotion or user intention that the user is currently experiencing.

As such, there is a need to address one or more of the above-identified challenges. A brief summary of solutions to the issues noted above are described below.

### SUMMARY

The methods, systems, and devices described herein provide personalized (instantaneous) visual representations of user intent, such as avatar stickers, that are tailored to match a user's intent (as interpreted by user input at a user device and/or based on data presented by the user device) and are visually communicative personalized representations of the users and/or user activity (e.g., activity that a user is engaged in, user location, props, pose, background, artistic coloring, etc.). The described systems and methods provide users with instant personalized avatar stickers that provide increased relevance, accuracy, variety, quality, and ease of use for integrating a user's feelings, personalized looks, and/or activities into online social communications. The methods, systems, and devices described herein allow users communicating via social media and/or text fields to creatively and accurately represent their emotions and/or desires through personalized and instantaneous compositions of avatar stickers based on a reflection of a variety of user facial expressions, user gestures, arrangements of text overlays (e.g., highlighting expressive feelings entered into text fields), user backgrounds, props, and other user-centric information (e.g., picture of a user's pet(s), home, vacation travel, fitness regimen, hobbies, and other activities).

The personalized and instantaneous generation of avatar stickers (also referred to as visual representations of user intent) increases the ability of users to interact with each other with more context, connection, deeper expressivity, relevance, greater engagement, and fulfillment, while reducing miscommunications that are increasingly common in a world driven by succinct and dry text feeds.

One example of a method for generating and displaying personalized instant avatar stickers is described herein. The example method is performed at a computing device and includes determining, based on textual data presented at the display communicatively coupled with the computing device, a user intent in responding to a portion of the textual data and generating one or more visual representations of the user intent. Each visual representation includes a representation of a user and an expression of the user intent performed by the representation of the user (e.g., an avatar). The example method further includes presenting the one or more visual representations of the user intent via the display communicatively coupled with the computing device and in response to user selection of a visual representation of the one or more visual representations, causing display of the visual representation in the text field.

In some embodiments, the expression of the user intent performed by the representation of the user may include a pose (e.g., a pose that is understandable and representative of the intent). In some embodiments, at least one visual representation includes a background contextualizing the user intent (e.g., the background is configured to help contextualize the expression of the user's intent without taking too much attention away from the user avatar), a text overlay contextualizing the user intent (e.g., a caption representative of the user intent) and/or a prop contextualizing the user intent (e.g., a coffee mug, a flag, and/or any other item that can be used to personalize the user avatar).

In some embodiments, the textual data presented at the display communicatively coupled with the computing device is a text input provided by the user (e.g., a search query made by the user, a portion of a message drafted by the user, an emoji, an emoticon, etc.) and causing the display of the visual representation in the text field includes replacing the text input with the visual representation.

In some embodiments, the textual data presented at the display communicatively coupled with the computing device can be a message received from at least one other user device and/or a message input by a user of the at least one other user device. In some embodiments, the user intent in responding to the portion of the data can include one or more of an emotional expression (e.g., happy, sad, etc.), an expression of interest (e.g., interest in a particular subject), participation in a moment (e.g., happy birthday, congratulations, etc.), and social engagement (e.g., greetings, conversation starters, etc.). Each visual representation of the user intent can include a degree of personalization. The degree of personalization can be one of universal use, niche use, and personalized use.

In some embodiments, generating the one or more visual representations of the user intent can include, for each visual representation, arranging one or more elements of the visual representation (e.g., resizing, recoloring, repositioning, cropping, masking, rotating the avatar, the background, the text overlay, the pose, the props, or portions thereof) to ensure that the elements are arranged harmoniously. The computing device may determine the user intent and generate the one or more visual representations of the determined user intent using a machine-learning model or an artificial intelligence model. The computing device can store the one or more visual representations of the user intent (e.g., associated with the user profile, stored in device memory, stored at a server, etc.). In some embodiments, the one or more visual representations of the user intent include a first visual representation of the user intent and a second visual representation of the user intent distinct from the first visual representation of the user intent (e.g., each of the visual representations is distinct).

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1H illustrate an example instant avatar generating machine-learning system, in accordance with some embodiments.

FIGS. 2A-2D illustrate another example instant avatar generating machine-learning system, in accordance with some embodiments.

FIG. 3 illustrates an example block diagram 300 for an instant avatar generating machine-learning system, in accordance with some embodiments.

FIG. 4 illustrates an example flow chart 400 for an instant avatar generating machine-learning method, in accordance with some embodiments.

FIGS. 5A and 5B illustrate example artificial-reality systems, in accordance with some embodiments.

FIGS. 6A-6B illustrate an example wrist-wearable device 600, in accordance with some embodiments.

FIGS. 7A-7B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

AR content can include completely generated content or generated content combined with captured (e.g., real-world) content. The AR content can include video, audio, haptic events, or some combination thereof, any of which can be presented in a single channel or in multiple channels (such as stereo video that produces a three-dimensional effect to a viewer). Additionally, in some embodiments, AR can also be associated with applications, products, accessories, services, or some combination thereof, which are used, for example, to create content in an AR and/or are otherwise used in (e.g., to perform activities in) an AR environment.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

As described herein, one or more machine-learning systems determine, based on a user input, user intent and generate a visual representation of a user, such as an avatar sticker, that expresses the user intent. The methods and devices described herein utilize textual data presented and/or received at a user device to determine a user intent in responding to a portion of the textual data and generate one or more visual representations of the user intent. The visual representations of the user intent can include a representation of the user (e.g., an avatar) and an expression of the user intent performed by the representation of the user. As described herein, the visual representations of the user intent can be shared with other users and/or stored for future use.

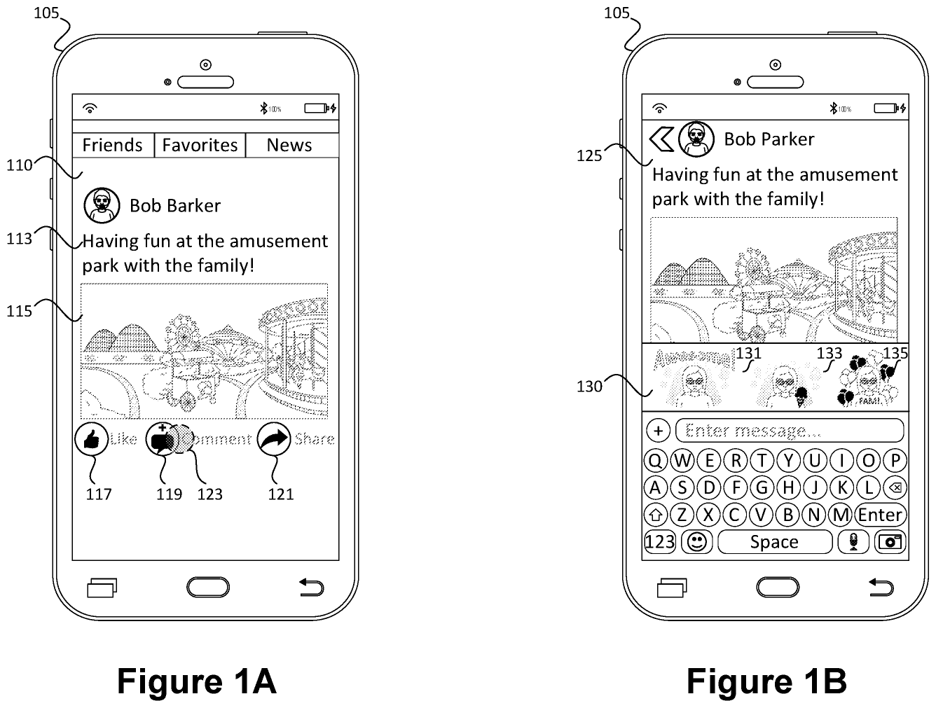

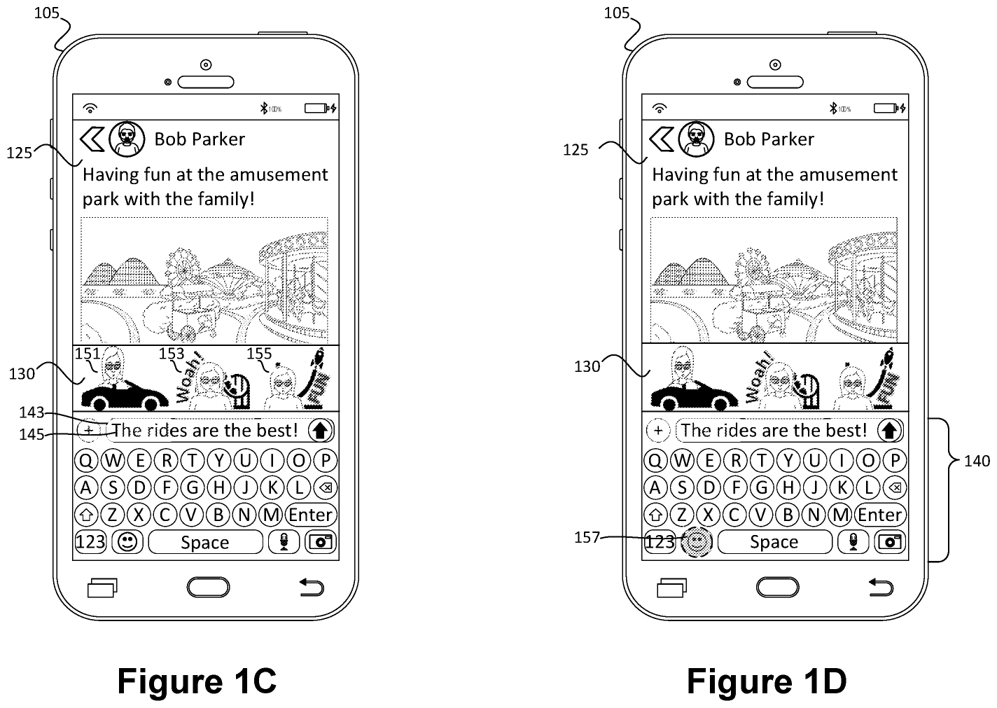

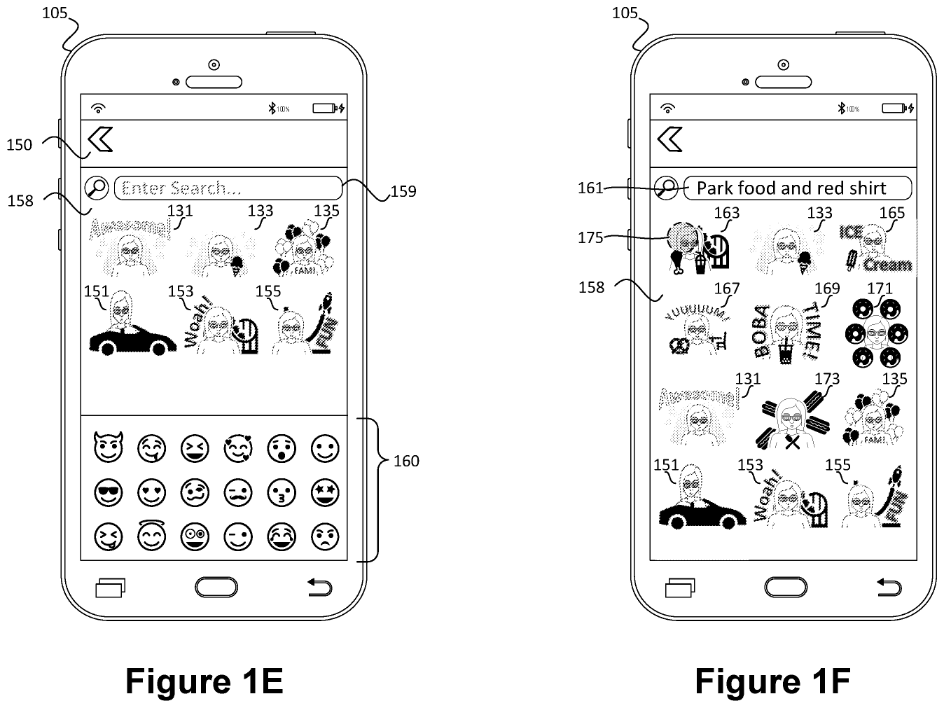

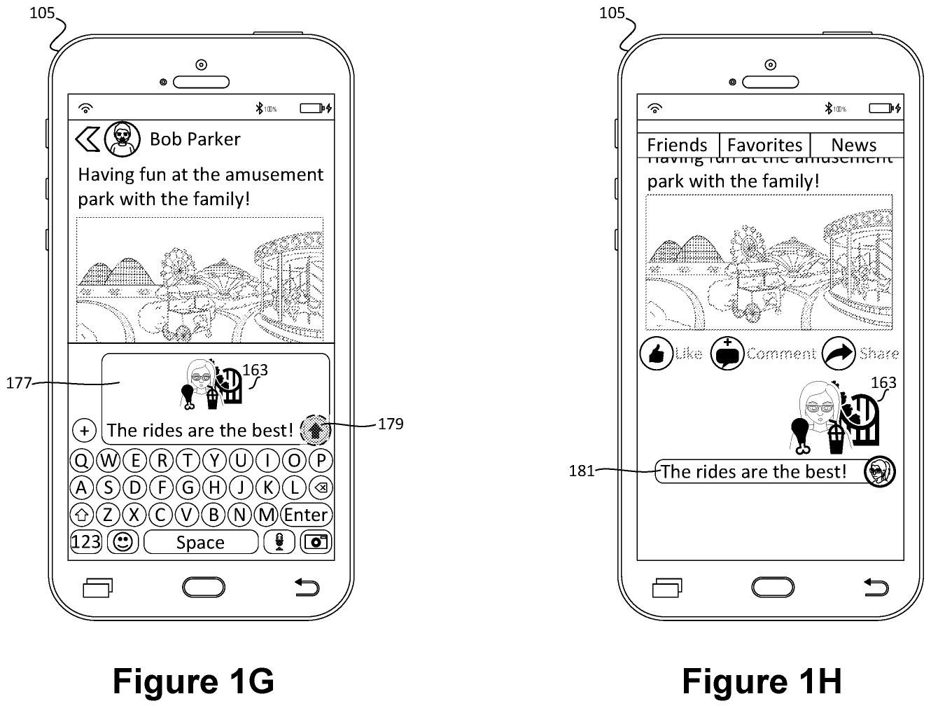

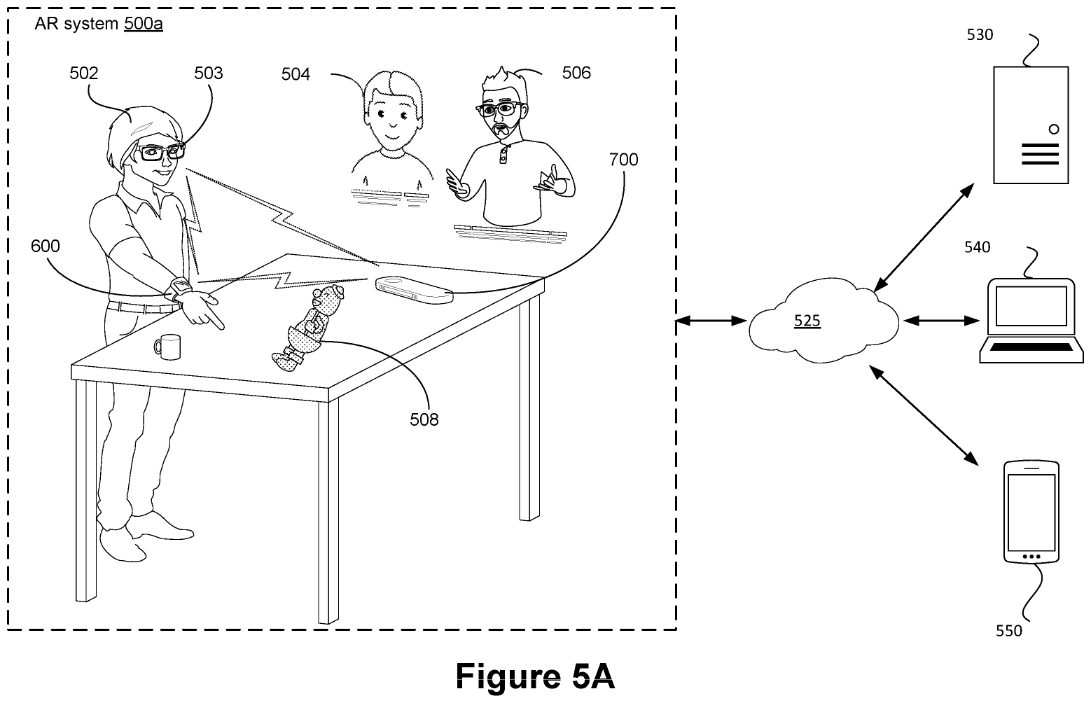

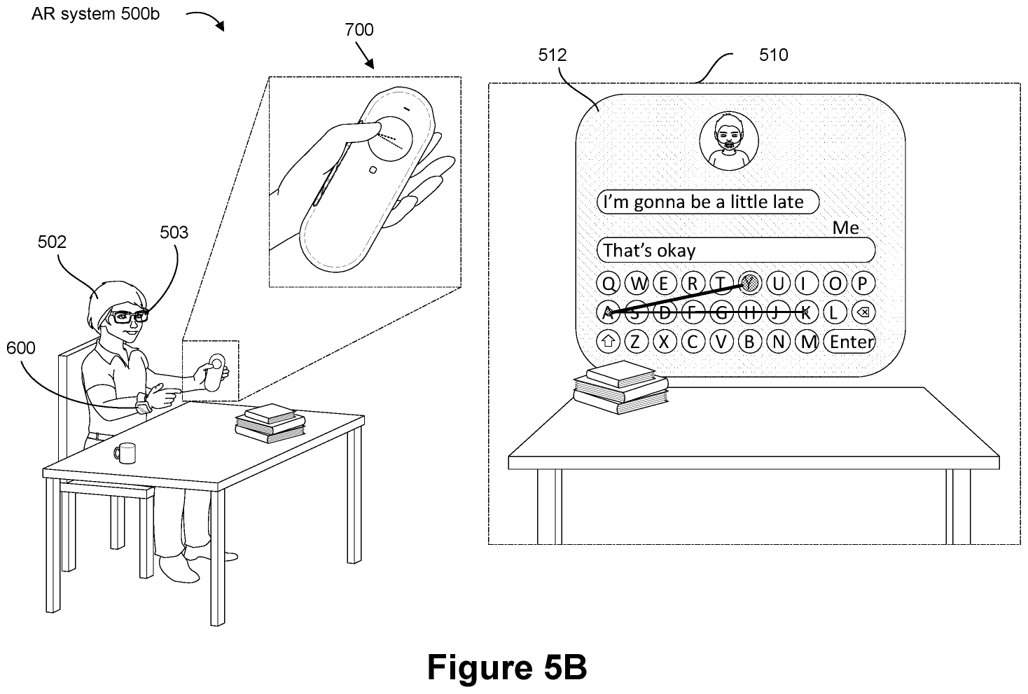

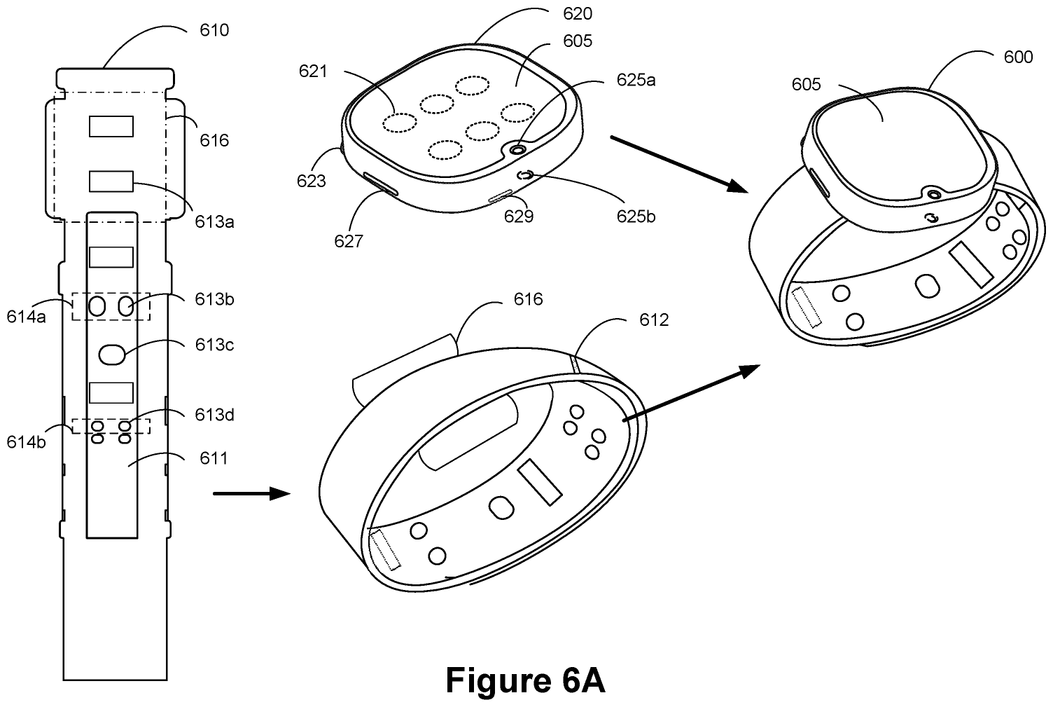

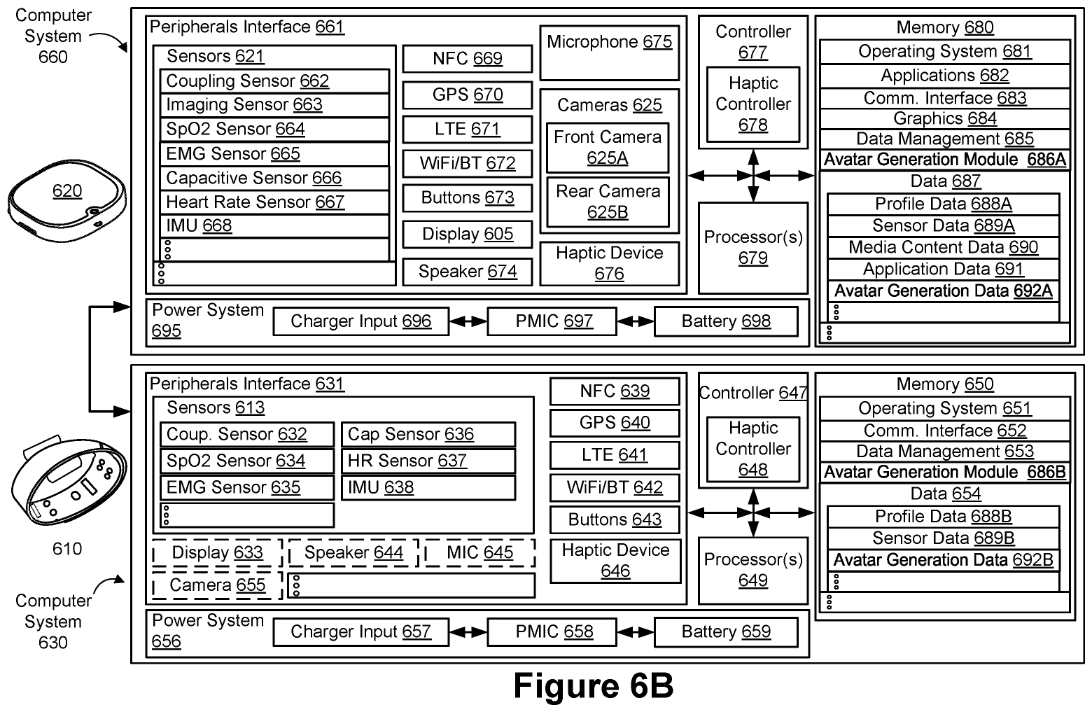

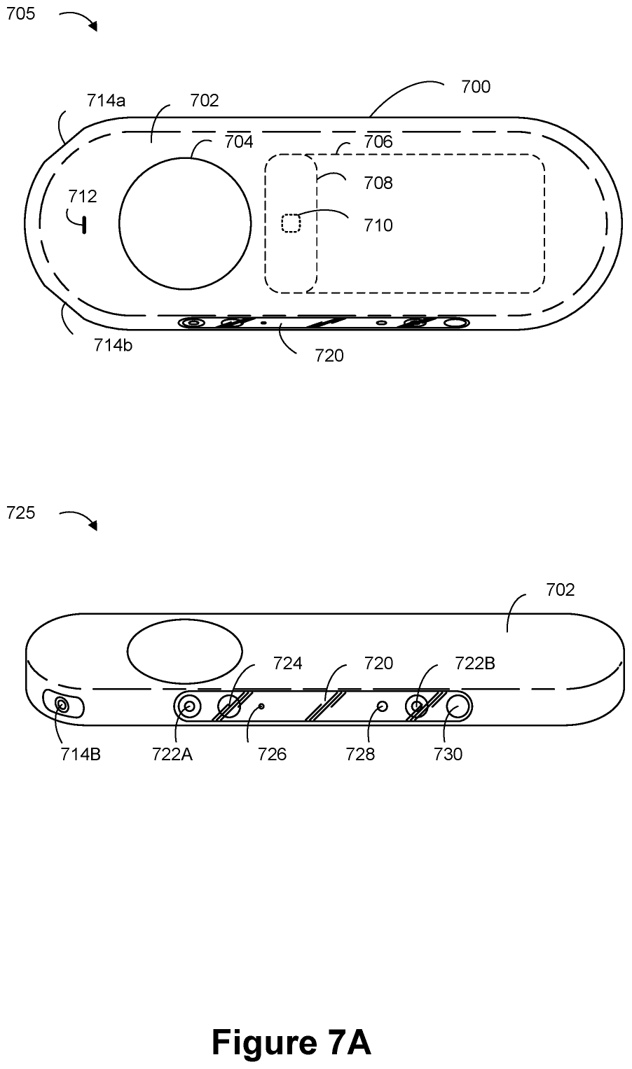

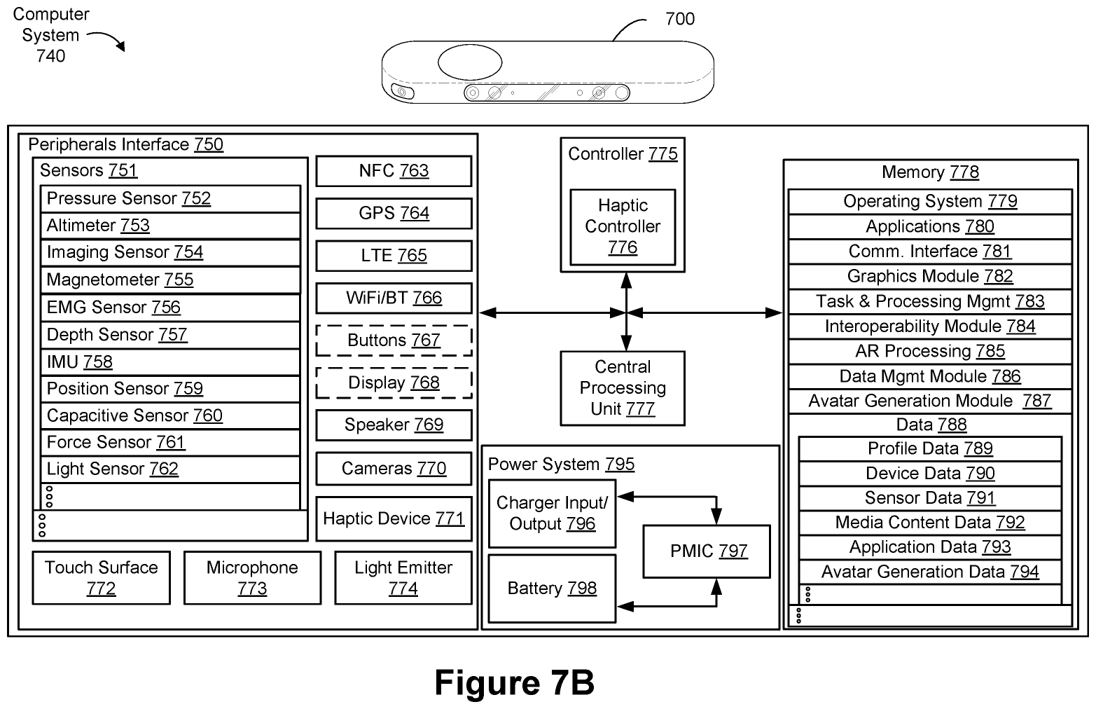

FIGS. 1A-1H illustrate generation of one or more visual representations of user intent at a user device, in accordance with some embodiments. In some embodiments, visual representations of user intent (e.g., instant avatar stickers) are composed (or generated) using an avatar generating machine-learning system (e.g., avatar generation module 686 and 787; FIGS. 6B and 7B) operating at a user device 105 (e.g., a smartphone) or at another device communicatively coupled with the user device 105 (e.g., a server 530, a computer 540; and/or any other device described below in reference to FIGS. 5A and 5B). The avatar generating machine-learning system is configured to generate expressive visual representations of user intent (e.g., an avatar) by arranging and/or modifying one or more assets (e.g., (avatar) poses, props, (animated or static) background, text overlays, and/or other elements) to convey user intent. A pose can be a user avatar position (e.g., way of standing, sitting, etc.) that is understandable and representative of the user intent. A background (e.g., an area, a scenery, etc.) is configured to help contextualize the user's intent without taking too much attention away from the avatar. A text overlay can include a caption representative of the user intent. A prop can be an asset item (e.g., a coffee mug, a flag, etc.) that is used to the user avatar to communicate user intent and/or further personalize the user avatar. The visual representations of user intent bridge existing content gaps (e.g., non-expressive avatars or non-existing avatars) and help users effortlessly express any intent through personalized and high-quality content (e.g., avatar stickers). The visual representations of user intent generated by the machine-learning system provide a greater variety of personalized content and tailored content for different users and/or regions.

User intents may include emotions (anger, happiness, joy, amazement, fear, etc.), interests (e.g., image of user lovingly holding a cat, textual data expressing love for a pet, etc.), moments (e.g., birthdays, national holidays, graduations, weddings, anniversaries, etc.), conversation building blocks (e.g., avatar recreating a famous greeting from a TV show and using a background from a scene in the TV show where the main character performed the greeting, avatar posing to match a way in which a user waves, avatar smiling the way the user smiles and a text caption reflecting an exact way in which the user is known to greet people, etc.), activities (work, sports, hiking, cooking, carpentry, artistry, etc.), and/or engagement type (e.g., positive engagement with social media content, negative or confrontational engagement with social media content).

FIG. 1A shows the user device 105 running an application, such as a social media application 110, a messaging application, and/or other application. The social media application 110 includes one or more messages, publications, and/or posts received and/or provided by a user associated with the user device 105. For example, in FIG. 1A, a contact of the user (e.g., Bob Barker) posted on the social media application 110 a description or status message 113 (e.g., Having fun at the amusement park with the family!) and an image 115 (e.g., an amusement park). The status message 113 and the image 115 posted by the contact of the user are associated with one or more user interface (UI) elements that, when selected, cause the performance of one or more operations for interacting with the post. For example, the status message 113 and the image 115 post can be associated with a “Like” UI element 117 that, when selected, allows the user to like the post; a “Comment” UI element 119 that, when selected, allows the user to comment on the post; and a “Share” UI element 121 that, when selected, allows the user to share the post with other users. The social media application 110 can receive a first user input 123 (e.g., via a touch input surface of the user device 105) when a user interacts with the social media application 110 to select the “Comment” UI element 119 and enter a comment corresponding to the status message 113 and/or the image 115. The above example interactions are non-limiting; a message, publication, and/or post can be associated with any number of interaction operations (e.g., dislike, hide, delete, mark read, mark unread, add a reminder, flag, etc.).

FIG. 1B shows a “Commenting” UI 125 presented at the user device 105. Specifically, a UI presented to the user in response to the first user input 123 selecting the “Comment” UI element 119. The user device 105, in response to the first user input 123, presents the “Commenting” UI 125 and a UI tray 130. The UI tray 130 includes one or more visual representations of user intent, such as a first visual representation of user intent 131, a second visual representation of user intent 133, and a third visual representation of user intent 135. Each of the visual representations of user intent included in the UI tray 130 are generated (e.g., by the avatar generating machine-learning system running on the user device 105 and/or other device communicatively coupled with the user device 105) based on data presented at the user device 105 as discussed below. In some embodiments, the UI tray 130 includes one or more previously generated and/or stored visual representation of user intent that are relevant to the data presented at the user device 105.

In some embodiments, each visual representation of the one or more visual representations 131, 133, and 135 is based on data associated with the user (e.g., name, profile, social media feeds, social media contacts, favorites, news feeds, etc.) and/or data included in the status message 113 and/or the image posted by the user's contact shared with the avatar generating machine-learning system. For example, the status message 113 includes data representative of the user's contact (e.g., social media friend, social media following, celebrity, etc.) having fun at an amusement park with family and the avatar generating machine-learning system generates, based on the status message 113, the one or more visual representations 131, 133, and 135. The avatar generating machine-learning system can generate any number of visual representations. In some embodiments, the avatar generating machine-learning system generates a predetermined number of visual representations (e.g., at least three, at least five, etc.). The UI tray 130 includes a predetermined number of relevant visual representations of a user's intent in commenting on the contact's status message 113 and/or image 115 (e.g., top three relevant visual representations of the user's intent).

Each of the visual representations includes a personalized avatar representing the user and/or background, props, text overlays, etc. that are tailored for relevance, accuracy, and/or creativity in giving expression to the user's intent in commenting on the contact's status message 113 and/or image 115. To protect user privacy, the avatar generating machine-learning system uses data that users have expressly granted permission to, shared on public forums, and/or shared with the avatar generating machine-learning system. Additionally, the avatar generating machine-learning system uses publicly available and/or publicly disclosed information when generating visual representations of users' intent.

FIG. 1C shows the commenting UI 125 presented in response to a user input. In particular, the commenting UI 125 shows one or more visual representations of user intent instantaneously generated, presented, and/or updated (e.g., fourth, fifth, and sixth visual representation of user intent 151, 153, and 155) within the UI tray 130 in response to entry of (textual) data in a text field 143 (e.g., user comment 145-“The rides are the best!”). A text field can be a message field, search bar, text prompt, etc. For example, a text field for a keyboard or a search query. Instantaneously generated, for purposes of this disclosure, means, in some embodiments, in real-time in response to user inputs and/or updates to data received at a user device. In some embodiments, the avatar generating machine-learning system generates and/or updates visual representation of user intent that are populated within the UI tray 130 while the user provides the data in a text field 143 (e.g., each input causes the UI tray 130 to be updated to include new, updated, and/or previously generated visual representation of user intent).

The visual representations of user intent provided by the avatar generating machine-learning system are based on the textual data provided by the user (e.g., comment 145), the status message 113, and/or the image 115. For example, the avatar generating machine-learning system uses the user's comment 145, the status message 113, and the image 115 to generate the fourth, fifth, and sixth visual representation of user intent 151, 153, and 155, which are a representation of the user on a ride, the user at an amusement park, and/or the user expressing their enjoyment (e.g., riding a rocket to the moon), respectively. In other words, the avatar generating machine-learning system extracts elements of the user's comment 145, the status message 113, and/or the image 115 to interpret the user's intentions and generates visual representation of the user's intent that can be shared to convey the user's intention.

The avatar generating machine-learning system is configured to harmoniously combine one or more assets such that each visual representation of user intent accurately conveys the user intent and is contextually accurate. For example, the user's avatar can be modified (e.g., resized, rotated, etc.) to fit with and/or use one or more props (e.g., a ride) and/or perform a pose to contextualize an action (e.g., avatar raise their hands during the ride to indicate excitement). As another example, the fifth visual representation 153 provides a representation of the user in front of an amusement park ride and includes a textual overlay (e.g., woah!) expressing the user's excitement (e.g., indicative of positive engagement with the status message 113 based on comment 145). In this way, the visual representations of user intent are displayed both in a realistic and personable manner and are not merely a superposition or side-by-side presentation of assets.

As a non-limiting example, the avatar generating machine-learning system can determine, based on shared data, an activity (hobby, work, personal time, errands, caregiving, etc.), a location (e.g., amusement park, aquarium, museum, business destination, meetup, etc.), an emotion (e.g., happy, sad, excited, grateful, ambitious, driven, focused, love, affection, jubilant, etc.), a desire (e.g., resolution, financial freedom, car, gift, good health, etc.), an action (e.g., working, eating, running, hiking, sports, etc.), and/or thought (e.g., philosophy, artistic expression, etc.) that the user is attempting to convey to others (e.g., through their inputs, relationship with a contact, and/or other shared information such as likes, dislikes, etc.). The avatar generating machine-learning system may analyze the image 115 alone, or in combination with the textual data, based on various image processing algorithms to refine a visual representation of user intent (e.g., a location, activity, interest, thought, etc.).

As described above, the UI tray 130 is updated in response to changes in the data presented and/or provided at the user device 105. In some embodiments, the UI tray 130 is updated to include a predetermined number of visual representations that satisfy a relevance threshold. The user can provide a user input at the UI tray 130 to scroll through different visual representations. For example, in FIG. 1C, the UI tray 130 includes the fourth, fifth, and sixth visual representation of user intent and a user input scrolling right and/or left (e.g., a touch and drag the touch input surface of the user device 105) can cause the UI tray 130 to present the first, second, and third visual representation of user intent 131, 133, and 135.

FIG. 1D shows an additional user input provided within the commenting UI 125. In situations where the user does not find a visual representation of user intent that accurately represents their intent or would like to view different visual representation of user intent (or other emoticons, emojis, etc.), the user can provide a second user input 157 (e.g., via a touch input surface of the user device 105) selecting an “Emoji” UI element within a virtual keyboard 140. The “Emoji” UI element, when selected, causes the user device 105 to present additional visual representation of user intent and/or allow the user to further personalize the visual representation of user intent as discussed below.

FIG. 1E shows an example “Emoji” UI 150 presented at the user device 105. The “Emoji” UI 150 includes an expanded UI tray 158 and an “Emoji” tray UI 160. The expanded UI tray 158 includes relevant and/or previously generated visual representation of user intent, and the “Emoji” tray UI 160 includes one or more predetermined “Emoji” UI elements, each of which, when selected, are included in a user's response (e.g., for review before sending). For example, the “Emoji” tray UI element 160 can include emoji's reflective of varying feelings (e.g., happy, hungry, laughing, amazed, unhappy, etc.) and the user can then select one of the emoji's presented in the “Emoji” tray UI element 160 to include the selected emoji in the response. Alternatively, or in addition, in some embodiments, the user can select the search text field 159 and provide additional inputs to generate and/or present visual representation of user intent, as shown in FIG. 1F.

FIG. 1F shows user input at the search text field 159. In particular, the user inputs search criteria (e.g., search terms 161-“park food and red shirt”) for locating and/or generating a visual representation of user intent. The user device 105, in response to receiving search criteria (or while the search terms 161 are being input), uses the avatar generating machine-learning system to generate and/or present visual representations of user intent, which are based on at least one or more of the status message 113, the image 115, the user's comment 145, and/or the search terms 161. The avatar generating machine-learning system can generate and/or present the visual representations of user intent in response to (1) search terms that trigger a sticker tray search (e.g., the UI tray 130 and/or the expanded UI tray 158 including a predetermined number of visual representations of user intent), (2) a contextual search based on content of the contact's post that the user is commenting on (e.g., causing presentation of the UI tray 130 or the expanded UI tray 158 and visual representations of user intent), and/or (3) a guided search based on the real-time search field input as the user is typing (e.g., instant generation of varying visual representations of user intent based on real-time inputs in a search field).

For example, the search terms 161 entered into search text field 159 causes the avatar generating machine-learning system to generate seventh through twelfth visual representation of user intent 163, 165, 167, 169, 171, and 173, each of which are based on at least one or more of the search terms 161, the status message 113, the image 115, and/or the user's comment 145. For example, the seventh through twelfth visual representation of user intent 163 through 173 include the user's avatar wearing a red shirt and eating food that is commonly associated with amusement parks (e.g., chicken, french-fries, boba, pretzels, doughnuts, etc.). In some embodiments, the previously generated visual representations of user intent are modified based on the search terms 161. For example, the first through fifth visual representation of user intent 131 through 135 and 151 through 155 are updated to include at least a red shirt or add a related prop (e.g., food or drink). In some embodiments, the user can input one or more emojis in search text field 159 to generate and/or present one or more visual representations of user intent.

The expanded UI tray 158 is updated to include the first through twelfth visual representation of user intent. The user can select visual representation of user intent that accurately captures their intent. For example, the user provides a third user input 175 selecting the seventh visual representation of user intent 163 based on their additional avatar stickers 163, 165, 167, 169, and 171 that Instant avatar stickers generated previously, but that are still deemed relevant, such as instant avatar stickers 131, 133, 135, 151, 153, and 155, are included in the UI display.

An order in which the visual representations of user intent are arranged for display can be based on a weighting score assigned to each visual representation of user intent based on a respective relevance, accuracy, popularity, and/or intent score. In some embodiments, the visual representation of user intent can be user editable through additional image editing tools included in the UI display.

The avatar generating machine-learning system provides a personalized approach for generating a variety of visual representations of user intent that are intuitive to generate, provide high-quality facial expressions, include a variety of poses (e.g., static, animated, avatar's outfit matches the intent, etc.), use hand gestures, include text overlays (e.g., static intent-driven stylized fonts, contextualized captions, pre-vetted captions, etc.), use props (e.g., static effect overlays, filters, animated effect overlays, etc.), and/or use backgrounds (e.g., generative static backgrounds, background shapes match user intent, etc.), and enable users to deeply express their thoughts and feelings. The visual representations of user intent provide creative freedom, enjoyment, attribution (e.g., a user can be recognized for creating a highly popular instant avatar), durability (e.g., user can have the option to reuse an avatar sticker in the future), and personalization.

FIG. 1G shows a comment text field 177 in response to selection of the seventh visual representation of user intent 163. The seventh visual representation of user intent 163, after being selected by the user, is presented along with the user's comment 145. The user can review the comment 145 and the seventh visual representation of user intent 163 before sending or posting the messages. In response to a fourth user input 179 confirming the comment 145 and the seventh visual representation of user intent 163 (e.g., selection of an “Enter” UI element), the user device 105 posts and/or sends the comment 145 and the seventh visual representation of user intent 163.

FIG. 1H shows the comment 145 and the seventh visual representation of user intent 163 posted (and/or displayed) in response to the contact's social media status message 113 and/or the image 115.

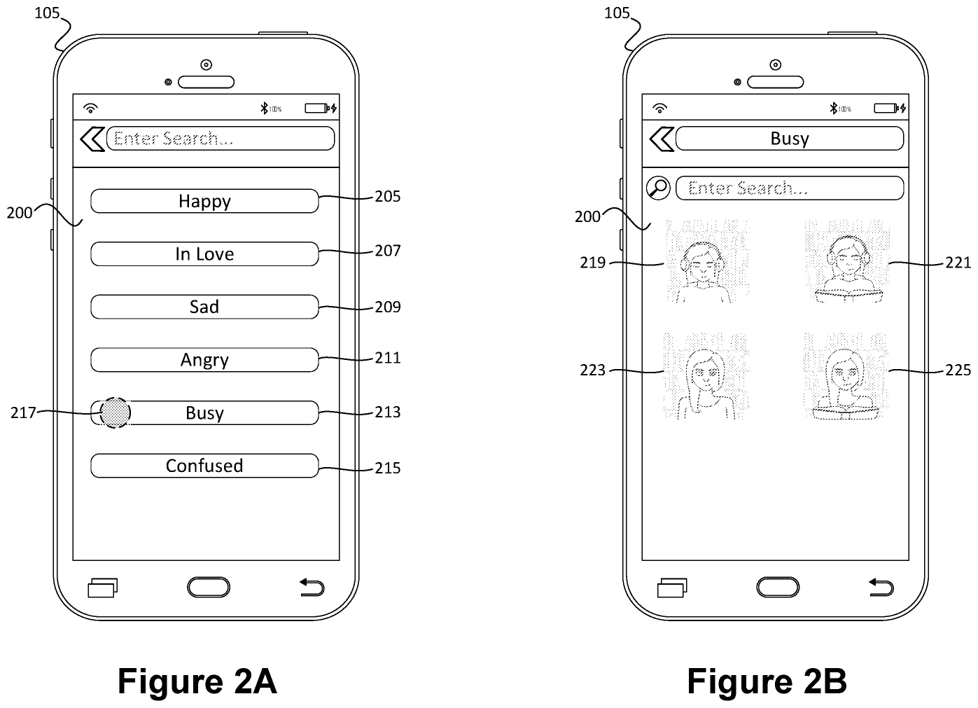

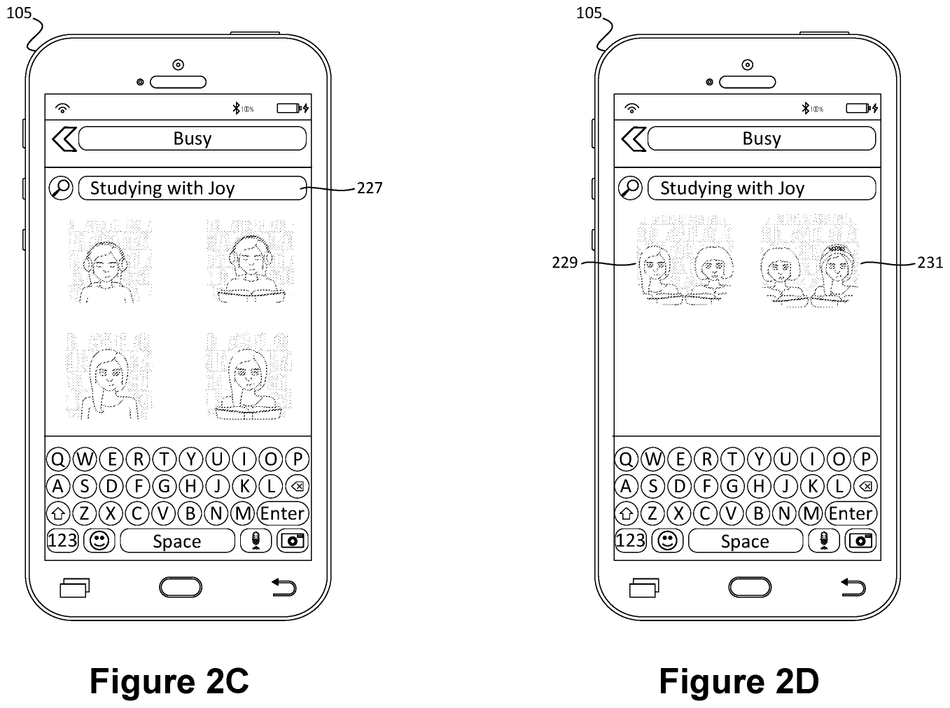

FIGS. 2A-2D illustrate generation of one or more additional visual representations of user intent at a user device, in accordance with some embodiments. In some embodiments, a user can provide an intent, emotion, etc. they would like to express via a visual representation of user intent. The user can select from one or more predefined criteria used by the avatar generating machine-learning system to generate one or more visual representations of user intent.

In FIG. 2A, the user device 105 presents an intent UI 200 including one or more UI elements associated with predefined criteria for generating visual representations of user intent. For example, the intent UI 200 includes selectable options representative of the human emotions or intent, such as a “Happy” UI element 205, an “In Love” UI element 207, a “Sad” UI element 209, an “Angry” UI element 211, a “Busy” UI element 213, a “Confused” UI element 215, etc. As further shown in FIG. 2A, the user selects “Busy” UI element 213 (e.g., via an input 217 at a touch surface).

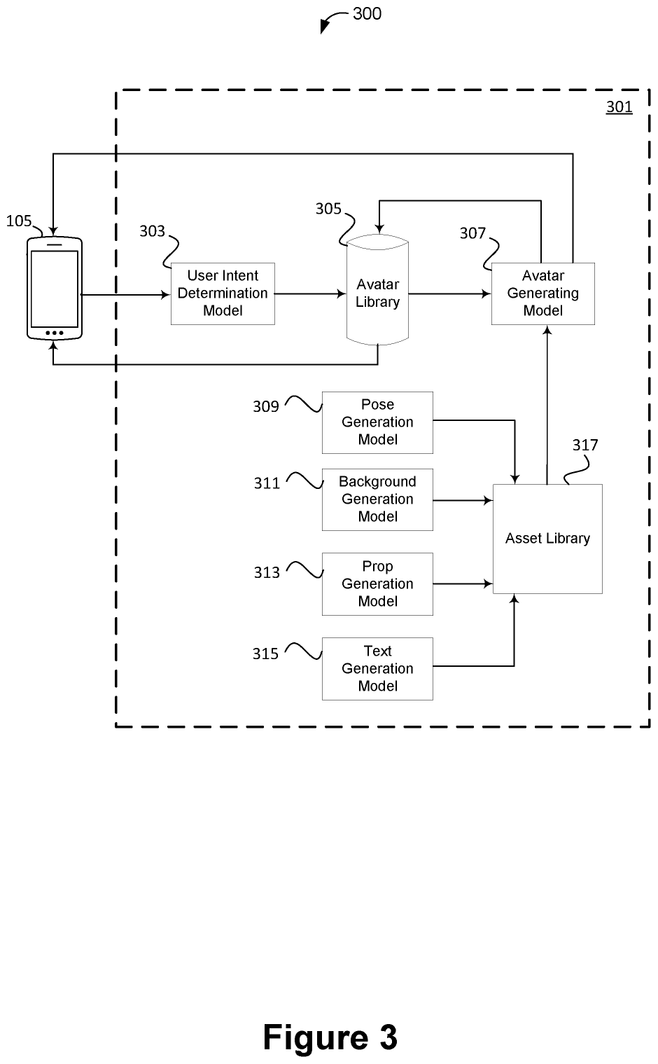

The avatar generating machine-learning system allows for a greater degree of personalization for the one or more visual representations. In some embodiments, one or more selectable UI elements presented via the user device allow the user to personalize the quality of the visual representations. For example, the one or more selectable UI elements can allow the user to alter the arrangement of the visual representations (e.g., select different composition rules that leverage design rules for asset sizes, relative positioning, color logic, cropping, masking, and/or rotation), select between different pose options for the visual representation (e.g., select from a predetermined number (e.g., 10, 50, 100) of static and animated poses in an asset library 317 (FIG. 3)), alter and/or personalize a text overlay by leveraging a predefined list of text overlays that maps user intents to captions, and/or select between different background options (e.g., full bleed, with various shapes, plain, etc.). In some embodiments, the avatar generating machine-learning system allows the user to select between different font styles and/or font colors for editing the text overlays. In some embodiments, the predefined list of text overlays can include text overlays that are ranked by user popularity for respective user intents.

FIG. 2B shows an avatar UI tray 220 including one or more visual representations of user intent based on the selected representative of the human emotions or intents (e.g., the “Busy” UI element 213). For example, user selection of the emotion “Busy” UI element 213 causes the avatar generating machine-learning system to generate one or more visual representations of a busy user 219, 221, 223, and 225. For example, a first visual representation of the busy user 219 includes a user avatar listening to audio (e.g., music, podcast, speech, etc.) with headphones; a second visual representation of the busy user 221 includes a user avatar reading a book and listening to audio while wearing headphones; a third visual representation of the busy user 223 includes a user avatar that is not engaged in any specific activity but is located at a library (represented by a background); and a fourth visual representation of the busy user 225 includes a user avatar reading a book at a library. In some embodiments, the intents of emotions, interests, backgrounds, props, poses, engagement types, and/or activities included in a visual representation are based on user history (e.g., frequently engaged activities, frequent responses, etc.), user provided context, user location, and/or other user information shared with the avatar generating machine-learning system by the user.

As described above in reference to FIG. 1F, the one or more visual representations of the busy user 219, 221, 223, and 225 can be presented in a predetermined order based on various weighting factors.

FIG. 2C shows user input provided to update and/or generate additional visual representations of the busy user. In FIG. 2C, the user inputs search criteria (e.g., search terms 227 “studying with Joy”) into a search text field (e.g., search text field 159; FIG. 1F). The avatar generating machine-learning system uses the search terms 227 to refine and/or more accurately represent the initial user intent (e.g., busy). For example, the avatar generating machine-learning system analyze the search terms 227 and uses the search terms 227 alone, or in combination with, the initial user intent (e.g., busy) to further personalize the visual representations of the busy user.

FIG. 2D shows the additional visual representations of the busy user based on the input search terms 227. In particular, the avatar generating machine-learning system analyzes “studying with Joy” together with the initial user defined emotion of “busy” to instantaneously generate the additional visual representations of the busy user 229 and 231. In some embodiments, the visual representations of a user intent can represent a user and a person they are currently with. For example, in FIG. 2D, the user is with her friend Joy and, as such, the additional visual representations of the busy user 229 and 231 show the user and an avatar representative of her friend Joy. Avatars representative of third parties (e.g., Joy) can be an avatar generated by the third party and associated with the social media application or other application that the user is using. Alternatively, the user can create an avatar for a particular contact or other person.

In some embodiments, avatars representative of third parties are based on the relationship between the user and the third party, user history with the third party, similarities with the third party, etc. For example, additional visual representation of the busy user 231 shows the user wearing a headdress with the word “Besties” to indicate that the user and Joy are best friends. Non-limiting examples of modifications to the user avatar or the third party avatar to indicate a prior relationship include modifications to the avatars clothes (e.g., school mascots, colors, text on clothing, etc.), text overlays that describe a relationship, poses performed by the avatars, proximity of the avatars, emotions expressed by the avatars, props used by the avatars, etc. In some embodiments, to protect the privacy of the third user, the third user avatar can be presented as shaded or censored to unrelated parties (e.g., contacts that are not friends with the user and the third party).

While the examples provided above are described as performed at a smartphone, the different functions and/or operations described above with reference to FIGS. 1A-2D can be performed at any electronic device (e.g., a wrist-wearable device 600, a head-wearable device, an HIPD 700, a server 530, a computer 540; and/or any other device described below in reference to FIGS. 5A and 5B) and/or combination of electronic devices. Additionally, visual representations of user intent can be generated for applications other than social media applications. For example, visual representations of user intent can be generated for messaging applications, web-browser applications, word-processing applications, and/or any other application that can run or be operated at an electronic device.

FIG. 3 illustrates an example block diagram 300 for an avatar generating machine-learning system, in accordance with some embodiments. In some embodiments, an example avatar generating machine-learning system 301 (e.g., an example of an avatar generation module 686 and 787; FIGS. 6B and 7B) includes a user intent determination model 303, an avatar library 305, an avatar generating model 307, a pose generation model 309, a background generation model 311, a prop generation model 313, a text generation model 315, and/or an asset library 317. In some embodiments, the example avatar generating machine-learning system 301 is stored on a user device 105 (e.g., in one or more programs or in memory) and/or stored on another device (e.g., a server, a computer, a handheld intermediary processing device, and/or other device described below in reference to FIGS. 5A and 5B) communicatively coupled with the user device 105. The user device 105 is configured to receive one or more user inputs (e.g., textual, visual, and/or AR data) and/or present one or more UIs (presenting data from one or more programs running on the user device, provided by a user via user inputs, and/or provided by another user device communicatively coupled with the user device 105), which are used to generate one or more visual representations of user intent by the example avatar generating machine-learning system 301 (as described above in reference to FIGS. 1A-2D).

The data received and/or presented via the user device 105 is provided to the user intent determination model 303. The user intent determination model 303 includes various machine learning algorithms to determine, extract, and/or interpret one or more user intents from the data provided by the user device 105. For example, as described above in reference to FIGS. 1A-2D, a feed of a social media application and/or a message thread of a messaging application can include data (e.g., textual data) that is used by an avatar generating machine-learning system, such as the example avatar generating machine-learning system 301, to infer a user intent in responding to a message, post, news feed, status update, etc.

A user intent determined by the user intent determination model 303 is used by the example avatar generating machine-learning system 301 to search for (within the avatar library 305) and/or (instantaneously) generate (using the avatar generating model 307) relevant visual representations of user intent. In particular, in accordance with a determination that visual representations of user intent within the asset library 305 satisfy relevance matching criteria (e.g., between the user intent determined by the user intent determination model 303 and existing visual representations), the example avatar generating machine-learning system 301 retrieves a predetermined number of relevant visual representations of user intent from the avatar library 305 and provides the predetermined number of relevant visual representations of user intent to the user device 105 for presentation to the user. For example, as described above in reference to FIGS. 1A-2D, relevant visual representations of user intent, based on data presented to and/or received from a user, are presented to the user via a UI tray 130 or an expanded UI tray 158.

Alternatively, or in addition, in accordance with a determination that visual representations of user intent within the asset library 305 do not satisfy the relevance matching criteria (and/or if additional visual representation are requested and/or needed to present a predetermined number of visual representations), the example avatar generating machine-learning system 301 provides the user intent, determined by the user intent determination model 303, to the avatar generating model 307. The avatar generating model 307 (instantaneously) generates one or more visual representations of user intent based on the determined user intent. The visual representations of user intent generated by the avatar generating model 307 are configured to satisfy the relevance matching criteria such that the visual representations of user intent are relevant and accurate for expressing the determined user intent.

The avatar generating model 307 can leverage assets stored in the asset library 317. The asset library 317 is a repository of one or more previously generated assets. For example, the asset library 317 can include one or more poses, backgrounds, props, text overlays, etc. The avatar generating model 307 retrieves one or more poses, backgrounds, props, text overlays, etc. from the asset library 317 to generate relevant visual representations of user intent. Each of the pose generation model 309, the background generation model 311, the prop generation model 313, and/or the text generation model 315 generate distinct, personalized, and customizable assets that are used to generate the visual representation of user intent. In some embodiments, the pose generation model 309, the background generation model 311, the prop generation model 313, and/or the text generation model 315 use data provided by the user, one or more applications running on the user device, and/or one or more communicatively coupled devices provided and/or publicly accessible data for generating assets that can be used by the avatar generating model 307.

The avatar generating model 307 instantaneously generates visual representations of user intent responsive to user input at the user device 105 and/or updates within an application running on the user device (e.g., a social media application, messaging application, etc.), as described above in reference to FIGS. 1A-2D. Visual representations of user intent generated by the avatar generating model 307 are provided to and stored at the avatar library 305 for retrieval. In some embodiments, an avatar generating machine-learning system is configured to continuously learn and update one or more models and/or assets for generating visual representations of user intent.

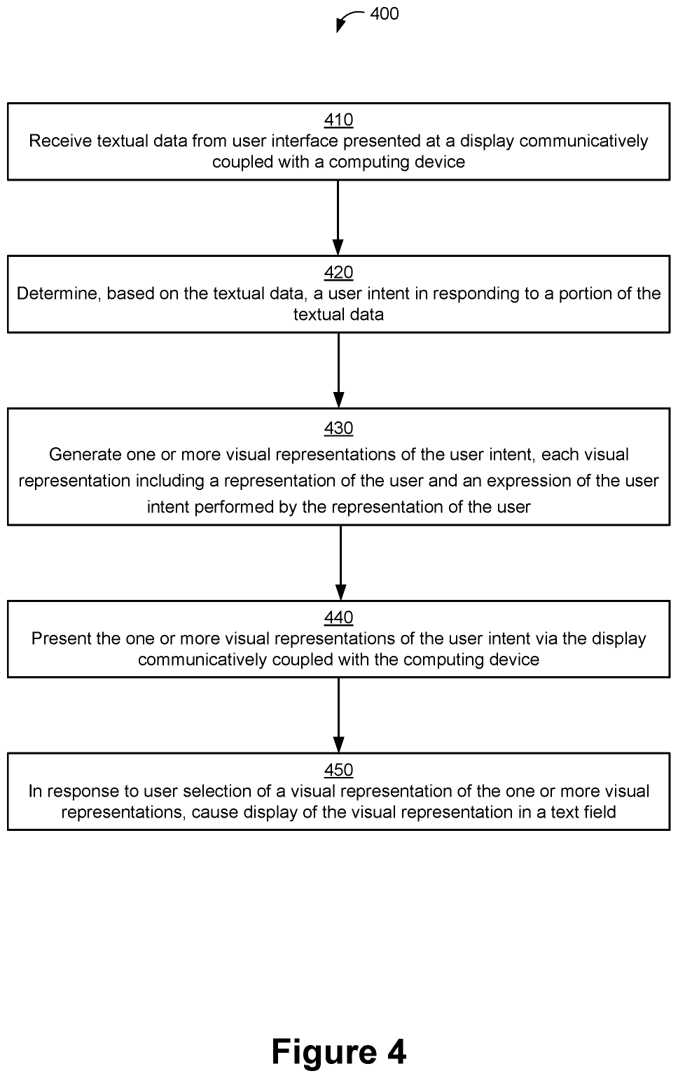

FIG. 4 illustrates a flow diagram 400 of a method of determining a user intent based on textual data, generating one or more visual representations of the user intent, each visual representation including a representation of the user and an expression of the user intent performed by the representation of the user. The method includes presenting the one or more visual representations of the user intent via a display communicatively coupled with a computing device and in response to user selection of a visual representation of the one or more visual representations, causing display of the visual representation in a text field in accordance with some embodiments. Operations (e.g., steps) of the method 400 can be performed by one or more processors (e.g., central processing unit and/or MCU) of a system (e.g., a mobile device 550, a wrist-wearable device 600, a head-wearable device, a handheld intermediary processing device 700, and/or any other device described below in reference to FIG. 5A). At least some of the operations shown in FIG. 4 correspond to instructions stored in a computer memory or computer-readable storage medium (e.g., storage, RAM, and/or memory, such as memory 680; FIG. 6B). Operations of the method 400 can be performed by a single device alone or in conjunction with one or more processors and/or hardware components of another communicatively coupled device (e.g., the wrist-wearable device 600 and a server 530, the wrist-wearable device 600 and the handheld intermediary processing device 700, etc.) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) FIG. 4 shows a flow chart of a method 400 of generating one or more visual representations based on a determined user intent, in accordance with some embodiments. The method 400 occurs at a computing device, such a mobile device 530, a wrist-wearable device 600, a handheld intermediary processing device 700 or other device described below in reference to FIG. 5A. In some embodiments, the method 400 includes, receiving (410) textual data from a user interface presented at a display communicatively coupled with the computing device. determining (420), based on the textual data, a user intent in responding to a portion of the textual data, and generating (430) one or more visual representations of the user intent. Each visual representation includes a representation of the user and an expression of the user intent performed by the representation of the user. The method 400 also includes presenting (440) the one or more visual representations of the user intent via the display communicatively coupled with the computing device and, in response to user selection of a visual representation of the one or more visual representations, causing (450) display of the visual representation in a text field (e.g., for review prior to sending or posting).
(A2) In some embodiments of A2, the expression of the user intent performed by the representation of the user includes a pose. A pose that is understandable and representative of the intent.
(A3) In some embodiments of A1-A2, at least one visual representation includes a background contextualizing the user intent. The backgrounds can help contextualize the expression's intent without taking too much attention away from the avatar.
(A4) In some embodiments of A1-A3, at least one visual representation includes a text overlay contextualizing the user intent (e.g., a caption representative of the user intent).
(A5) In some embodiments of A1-A4, at least one visual representation includes a prop contextualizing the user intent. For example, a prop can include a coffee mug, a flag, and/or any other item that can be used to personalize the user avatar.
(A6) In some embodiments of A1-A5, the textual data presented at the display communicatively coupled with the computing device is a text input provided by the user (e.g., a search query made by the user, a portion of a message drafted by the user, an emoji, an emoticon, etc.); and causing display of the visual representation in the text field includes replacing the text input with the visual representation.
(A7) In some embodiments of A1-A6, the textual data presented at the display communicatively coupled with the computing device is a message received from at least one other user (e.g., a post, a comment, an update, a story, and/or any other textual data provided by another party).
(A8) In some embodiments of A1-A7, the user intent in responding to the portion of the data includes one or more of an emotional expression (e.g., happy, sad, etc.), an expression of interest (e.g., interest in a particular subject), participation in a moment (e.g., happy birthday, congratulations, etc.), and social engagement (e.g., greetings, conversation starters, etc.).
(A9) In some embodiments of A1-A8, each visual representation of the user intent includes a degree of personalization.
(A10) In some embodiments of A1-A9, the degree of personalization is one of universal use, niche use, and personalized use. More specifically, the visual representation of user intent can be formed for a universal use (e.g., everyday event, standard greeting, standard celebration (e.g., happy birthday), etc.), niche use (e.g., specific to a particular user event, user greeting, user celebration, etc.), or personal use (e.g., user communication with a particular contact, customized avatar, etc.). Additional non-limiting examples of user intent include expression of human emotions, intent in showing a degree of interest, participation or including in a moment (e.g., birthday), conversational building blocks, etc.
(A11) In some embodiments of A1-A10, generating the one or more visual representations of the user intent includes, for each visual representation, arranging one or more elements of the visual representation. As described above in reference to FIGS. 1A-2D, the visual representations of user intent can be customized and or personalized. In some embodiments, the generation or composition of visual representations of user intent can include resizing, recoloring, repositioning, cropping, masking, rotating of an avatar or asset, changes to a background, changes to a text overlay, changes to a pose, change in props, and/or combinations thereof.
(A12) In some embodiments of A1-A11, the user intent is determined, and the one or more visual representations of the user intent are generated using a machine-learning model or an artificial intelligence model. Examples of the different models are described above in reference to FIG. 3.
(A13) In some embodiments of A1-A12, the one or more visual representations of the user intent are stored (e.g., an asset library 305 (FIG. 3) stored in memory). In some embodiments, the stored visual representations of the user intent are associated with a user profile, stored in device memory, stored at a server, etc.
(A14) In some embodiments of A1-A13, the one or more visual representations of the user intent include a first visual representation of the user intent and a second visual representation of the user intent distinct from the first visual representation of the user intent. In other words, each of the visual representations is distinct.
(B1) In accordance with some embodiments, a system that includes one or more wrist wearable devices, an artificial-reality headset, an handheld intermediary processing device, and a mobile device, and the system is configured to perform operations corresponding to any of A1-A14.
(C1) In accordance with some embodiments, a non-transitory computer readable storage medium including instructions that, when executed by a computing device, cause the computer device to perform operations corresponding to any of A1-A14.
(D1) In accordance with some embodiments, a computing device including one or more programs, the one or more programs are stored in memory and configured to be executed by one or more processors, the one or more programs including instructions for performing operations that correspond to any of A1-A14.
(E1) In accordance with some embodiments, a means for performing operations that correspond to any of A1-A14.

The devices described above are further detailed below, including systems, wrist-wearable devices, and headset devices. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 600, a head-wearable device, an HIPD 700, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 5A and 5B illustrate example AR systems, in accordance with some embodiments. FIG. 5A shows a first AR system 500a and first example user interactions using a wrist-wearable device 600, a head-wearable device (e.g., AR device 503 or a VR device), and/or a handheld intermediary processing device (HIPD) 700. FIG. 5B shows a second AR system 500b and second example user interactions using a wrist-wearable device 600, AR device 503, and/or an HIPD 700. As the skilled artisan will appreciate upon reading the descriptions provided herein, the above-example AR systems (described in detail below) can perform various functions and/or operations described above with reference to FIGS. 1A-4.

The wrist-wearable device 600 and its constituent components are described below in reference to FIGS. 6A-6B and the HIPD 700 and its constituent components are described below in reference to FIGS. 7A-7B. The wrist-wearable device 600, the head-wearable devices, and/or the HIPD 700 can communicatively couple via a network 525 (e.g., cellular, near field, Wi-Fi, personal area network, wireless LAN, etc.). Additionally, the wrist-wearable device 600, the head-wearable devices, and/or the HIPD 700 can also communicatively couple with one or more servers 530, computers 540 (e.g., laptops, computers, etc.), mobile devices 550 (e.g., smartphones, tablets, etc.), and/or other electronic devices via the network 525 (e.g., cellular, near field, Wi-Fi, personal area network, wireless LAN, etc.)

Turning to FIG. 5A, a user 502 is shown wearing the wrist-wearable device 600 and the AR device 503, and having the HIPD 700 on their desk. The wrist-wearable device 600, the AR device 503, and the HIPD 700 facilitate user interaction with an AR environment. In particular, as shown by the first AR system 500a, the wrist-wearable device 600, the AR device 503, and/or the HIPD 700 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 600, the AR device 503, and/or the HIPD 700.

The user 502 can use any of the wrist-wearable device 600, the AR device 503, and/or the HIPD 700 to provide user inputs. For example, the user 502 can perform one or more hand gestures that are detected by the wrist-wearable device 600 (e.g., using one or more EMG sensors and/or IMUs, described below in reference to FIGS. 6A-6B) and/or AR device 503 (e.g., using one or more image sensors or cameras) to provide a user input. Alternatively, or additionally, the user 502 can provide a user input via one or more touch surfaces of the wrist-wearable device 600, the AR device 503, and/or the HIPD 700, and/or voice commands captured by a microphone of the wrist-wearable device 600, the AR device 503, and/or the HIPD 700. In some embodiments, the wrist-wearable device 600, the AR device 503, and/or the HIPD 700 include a digital assistant to help the user in providing a user input (e.g., completing a sequence of operations, suggesting different operations or commands, providing reminders, confirming a command). In some embodiments, the user 502 can provide a user input via one or more facial gestures and/or facial expressions. For example, cameras of the wrist-wearable device 600, the AR device 503, and/or the HIPD 700 can track the user 502's eyes for navigating a user interface.

The wrist-wearable device 600, the AR device 503, and/or the HIPD 700 can operate alone or in conjunction to allow the user 502 to interact with the AR environment. In some embodiments, the HIPD 700 is configured to operate as a central hub or control center for the wrist-wearable device 600, the AR device 503, and/or another communicatively coupled device. For example, the user 502 can provide an input to interact with the AR environment at any of the wrist-wearable device 600, the AR device 503, and/or the HIPD 700, and the HIPD 700 can identify one or more back-end and front-end tasks to cause the performance of the requested interaction and distribute instructions to cause the performance of the one or more back-end and front-end tasks at the wrist-wearable device 600, the AR device 503, and/or the HIPD 700. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 7A-7B, the HIPD 700 can perform the back-end tasks and provide the wrist-wearable device 600 and/or the AR device 503 operational data corresponding to the performed back-end tasks such that the wrist-wearable device 600 and/or the AR device 503 can perform the front-end tasks. In this way, the HIPD 700, which has more computational resources and greater thermal headroom than the wrist-wearable device 600 and/or the AR device 503, performs computationally intensive tasks and reduces the computer resource utilization and/or power usage of the wrist-wearable device 600 and/or the AR device 503.

In the example shown by the first AR system 500a, the HIPD 700 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 700 performs back-end tasks for processing and/or rendering image data (and other data) associated with the AR video call and provides operational data associated with the performed back-end tasks to the AR device 503 such that the AR device 503 performs front-end tasks for presenting the AR video call (e.g., presenting the avatar 504 and the digital representation of the contact 506).

In some embodiments, the HIPD 700 can operate as a focal or anchor point for causing the presentation of information. This allows the user 502 to be generally aware of where information is presented. For example, as shown in the first AR system 500a, the avatar 504 and the digital representation of the contact 506 are presented above the HIPD 700. In particular, the HIPD 700 and the AR device 503 operate in conjunction to determine a location for presenting the avatar 504 and the digital representation of the contact 506. In some embodiments, information can be presented within a predetermined distance from the HIPD 700 (e.g., within five meters). For example, as shown in the first AR system 500a, virtual object 508 is presented on the desk some distance from the HIPD 700. Similar to the above example, the HIPD 700 and the AR device 503 can operate in conjunction to determine a location for presenting the virtual object 508. Alternatively, in some embodiments, presentation of information is not bound by the HIPD 700. More specifically, the avatar 504, the digital representation of the contact 506, and the virtual object 508 do not have to be presented within a predetermined distance of the HIPD 700.

User inputs provided at the wrist-wearable device 600, the AR device 503, and/or the HIPD 700 are coordinated such that the user can use any device to initiate, continue, and/or complete an operation. For example, the user 502 can provide a user input to the AR device 503 to cause the AR device 503 to present the virtual object 508 and, while the virtual object 508 is presented by the AR device 503, the user 502 can provide one or more hand gestures via the wrist-wearable device 600 to interact and/or manipulate the virtual object 508.

FIG. 5B shows the user 502 wearing the wrist-wearable device 600 and the AR device 503, and holding the HIPD 700. In the second AR system 500b, the wrist-wearable device 600, the AR device 503, and/or the HIPD 700 are used to receive and/or provide one or more messages to a contact of the user 502. In particular, the wrist-wearable device 600, the AR device 503, and/or the HIPD 700 detect and coordinate one or more user inputs to initiate a messaging application and prepare a response to a received message via the messaging application.

In some embodiments, the user 502 initiates, via a user input, an application on the wrist-wearable device 600, the AR device 503, and/or the HIPD 700 that causes the application to initiate on at least one device. For example, in the second AR system 500b the user 502 performs a hand gesture associated with a command for initiating a messaging application (represented by messaging user interface 512); the wrist-wearable device 600 detects the hand gesture; and, based on a determination that the user 502 is wearing AR device 503, causes the AR device 503 to present a messaging user interface 512 of the messaging application. The AR device 503 can present the messaging user interface 512 to the user 502 via its display (e.g., as shown by user 502's field of view 510). In some embodiments, the application is initiated and can be run on the device (e.g., the wrist-wearable device 600, the AR device 503, and/or the HIPD 700) that detects the user input to initiate the application, and the device provides another device operational data to cause the presentation of the messaging application. For example, the wrist-wearable device 600 can detect the user input to initiate a messaging application, initiate and run the messaging application, and provide operational data to the AR device 503 and/or the HIPD 700 to cause presentation of the messaging application. Alternatively, the application can be initiated and run at a device other than the device that detected the user input. For example, the wrist-wearable device 600 can detect the hand gesture associated with initiating the messaging application and cause the HIPD 700 to run the messaging application and coordinate the presentation of the messaging application.

Further, the user 502 can provide a user input provided at the wrist-wearable device 600, the AR device 503, and/or the HIPD 700 to continue and/or complete an operation initiated at another device. For example, after initiating the messaging application via the wrist-wearable device 600 and while the AR device 503 presents the messaging user interface 512, the user 502 can provide an input at the HIPD 700 to prepare a response (e.g., shown by the swipe gesture performed on the HIPD 700). The user 502's gestures performed on the HIPD 700 can be provided and/or displayed on another device. For example, the user 502's swipe gestures performed on the HIPD 700 are displayed on a virtual keyboard of the messaging user interface 512 displayed by the AR device 503.

In some embodiments, the wrist-wearable device 600, the AR device 503, the HIPD 700, and/or other communicatively coupled devices can present one or more notifications to the user 502. The notification can be an indication of a new message, an incoming call, an application update, a status update, etc. The user 502 can select the notification via the wrist-wearable device 600, the AR device 503, or the HIPD 700 and cause presentation of an application or operation associated with the notification on at least one device. For example, the user 502 can receive a notification that a message was received at the wrist-wearable device 600, the AR device 503, the HIPD 700, and/or other communicatively coupled device and provide a user input at the wrist-wearable device 600, the AR device 503, and/or the HIPD 700 to review the notification, and the device detecting the user input can cause an application associated with the notification to be initiated and/or presented at the wrist-wearable device 600, the AR device 503, and/or the HIPD 700.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 503 can present to the user 502 game application data and the HIPD 700 can use a controller to provide inputs to the game. Similarly, the user 502 can use the wrist-wearable device 600 to initiate a camera of the AR device 503, and the user can use the wrist-wearable device 600, the AR device 503, and/or the HIPD 700 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 6A and 6B illustrate an example wrist-wearable device 600, in accordance with some embodiments. The wrist-wearable device 600 is an instance of the wearable device described in reference to FIG. 4 herein, such that the wrist-wearable devices should be understood to have the features of the wrist-wearable device 600 and vice versa. FIG. 6A illustrates components of the wrist-wearable device 600, which can be used individually or in combination, including combinations that include other electronic devices and/or electronic components.

FIG. 6A shows a wearable band 610 and a watch body 620 (or capsule) being coupled, as discussed below, to form the wrist-wearable device 600. The wrist-wearable device 600 can perform various functions and/or operations associated with navigating through user interfaces and selectively opening applications, as well as the functions and/or operations described above with reference to FIGS. 1A-4.

As will be described in more detail below, operations executed by the wrist-wearable device 600 can include (i) presenting content to a user (e.g., displaying visual content via a display 605); (ii) detecting (e.g., sensing) user input (e.g., sensing a touch on peripheral button 623 and/or at a touch screen of the display 605, a hand gesture detected by sensors (e.g., biopotential sensors)); (iii) sensing biometric data via one or more sensors 613 (e.g., neuromuscular signals, heart rate, temperature, sleep, etc.); messaging (e.g., text, speech, video, etc.); image capture via one or more imaging devices or cameras 625; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 620, independently in the wearable band 610, and/or via an electronic communication between the watch body 620 and the wearable band 610. In some embodiments, functions can be executed on the wrist-wearable device 600 while an AR environment is being presented (e.g., via one of the AR systems 500a and 500b). As the skilled artisan will appreciate upon reading the descriptions provided herein, the novel wearable devices described herein can be used with other types of AR environments.

The wearable band 610 can be configured to be worn by a user such that an inner (or inside) surface of the wearable structure 611 of the wearable band 610 is in contact with the user's skin. When worn by a user, sensors 613 contact the user's skin. The sensors 613 can sense biometric data such as a user's heart rate, saturated oxygen level, temperature, sweat level, neuromuscular signal sensors, or a combination thereof. The sensors 613 can also sense data about a user's environment, including a user's motion, altitude, location, orientation, gait, acceleration, position, or a combination thereof. In some embodiments, the sensors 613 are configured to track a position and/or motion of the wearable band 610. The one or more sensors 613 can include any of the sensors defined above and/or discussed below with respect to FIG. 6B.

The one or more sensors 613 can be distributed on an inside and/or an outside surface of the wearable band 610. In some embodiments, the one or more sensors 613 are uniformly spaced along the wearable band 610. Alternatively, in some embodiments, the one or more sensors 613 are positioned at distinct points along the wearable band 610. As shown in FIG. 6A, the one or more sensors 613 can be the same or distinct. For example, in some embodiments, the one or more sensors 613 can be shaped as a pill (e.g., sensor 613a), an oval, a circle a square, an oblong (e.g., sensor 613c) and/or any other shape that maintains contact with the user's skin (e.g., such that neuromuscular signal and/or other biometric data can be accurately measured at the user's skin). In some embodiments, the one or more sensors 613 are aligned to form pairs of sensors (e.g., for sensing neuromuscular signals based on differential sensing within each respective sensor). For example, sensor 613b is aligned with an adjacent sensor to form sensor pair 614a and sensor 613d is aligned with an adjacent sensor to form sensor pair 614b. In some embodiments, the wearable band 610 does not have a sensor pair. Alternatively, in some embodiments, the wearable band 610 has a predetermined number of sensor pairs (one pair of sensors, three pairs of sensors, four pairs of sensors, six pairs of sensors, sixteen pairs of sensors, etc.).

The wearable band 610 can include any suitable number of sensors 613. In some embodiments, the number and arrangements of sensors 613 depend on the particular application for which the wearable band 610 is used. For instance, a wearable band 610 configured as an armband, wristband, or chest-band may include a plurality of sensors 613 with different number of sensors 613 and different arrangement for each use case, such as medical use cases, compared to gaming or general day-to-day use cases.

In accordance with some embodiments, the wearable band 610 further includes an electrical ground electrode and a shielding electrode. The electrical ground and shielding electrodes, like the sensors 613, can be distributed on the inside surface of the wearable band 610 such that they contact a portion of the user's skin. For example, the electrical ground and shielding electrodes can be at an inside surface of coupling mechanism 616 or an inside surface of a wearable structure 611. The electrical ground and shielding electrodes can be formed and/or use the same components as the sensors 613. In some embodiments, the wearable band 610 includes more than one electrical ground electrode and more than one shielding electrode.

The sensors 613 can be formed as part of the wearable structure 611 of the wearable band 610. In some embodiments, the sensors 613 are flush or substantially flush with the wearable structure 611 such that they do not extend beyond the surface of the wearable structure 611. While flush with the wearable structure 611, the sensors 613 are still configured to contact the user's skin (e.g., via a skin-contacting surface). Alternatively, in some embodiments, the sensors 613 extend beyond the wearable structure 611 a predetermined distance (e.g., 0.1 mm to 2 mm) to make contact and depress into the user's skin. In some embodiments, the sensors 613 are coupled to an actuator (not shown) configured to adjust an extension height (e.g., a distance from the surface of the wearable structure 611) of the sensors 613 such that the sensors 613 make contact and depress into the user's skin. In some embodiments, the actuators adjust the extension height between 0.01 mm to 1.2 mm. This allows the user to customize the positioning of the sensors 613 to improve the overall comfort of the wearable band 610 when worn while still allowing the sensors 613 to contact the user's skin. In some embodiments, the sensors 613 are indistinguishable from the wearable structure 611 when worn by the user.

The wearable structure 611 can be formed of an elastic material, elastomers, etc., configured to be stretched and fitted to be worn by the user. In some embodiments, the wearable structure 611 is a textile or woven fabric. As described above, the sensors 613 can be formed as part of a wearable structure 611. For example, the sensors 613 can be molded into the wearable structure 611 or be integrated into a woven fabric (e.g., the sensors 613 can be sewn into the fabric and mimic the pliability of fabric (e.g., the sensors 613 can be constructed from a series of woven strands of fabric)).

The wearable structure 611 can include flexible electronic connectors that interconnect the sensors 613, the electronic circuitry, and/or other electronic components (described below in reference to FIG. 6B) that are enclosed in the wearable band 610. In some embodiments, the flexible electronic connectors are configured to interconnect the sensors 613, the electronic circuitry, and/or other electronic components of the wearable band 610 with respective sensors and/or other electronic components of another electronic device (e.g., watch body 620). The flexible electronic connectors are configured to move with the wearable structure 611 such that the user adjustment to the wearable structure 611 (e.g., resizing, pulling, folding, etc.) does not stress or strain the electrical coupling of components of the wearable band 610.

As described above, the wearable band 610 is configured to be worn by a user. In particular, the wearable band 610 can be shaped or otherwise manipulated to be worn by a user. For example, the wearable band 610 can be shaped to have a substantially circular shape such that it can be configured to be worn on the user's lower arm or wrist. Alternatively, the wearable band 610 can be shaped to be worn on another body part of the user, such as the user's upper arm (e.g., around a bicep), forearm, chest, legs, etc. The wearable band 610 can include a retaining mechanism 612 (e.g., a buckle, a hook and loop fastener, etc.) for securing the wearable band 610 to the user's wrist or other body part. While the wearable band 610 is worn by the user, the sensors 613 sense data (referred to as sensor data) from the user's skin. In particular, the sensors 613 of the wearable band 610 obtain (e.g., sense and record) neuromuscular signals.

The sensed data (e.g., sensed neuromuscular signals) can be used to detect and/or determine the user's intention to perform certain motor actions. In particular, the sensors 613 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 605 of the wrist-wearable device 600 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 613 can be used to provide a user with an enhanced interaction with a physical object (e.g., devices communicatively coupled with the wearable band 610) and/or a virtual object in an artificial-reality application generated by an artificial-reality system (e.g., user interface objects presented on the display 605 or another computing device (e.g., a smartphone)).

In some embodiments, the wearable band 610 includes one or more haptic devices 646 (FIG. 6B; e.g., a vibratory haptic actuator) that are configured to provide haptic feedback (e.g., a cutaneous and/or kinesthetic sensation, etc.) to the user's skin. The sensors 613, and/or the haptic devices 646 can be configured to operate in conjunction with multiple applications including, without limitation, health monitoring, social media, games, and artificial reality (e.g., the applications associated with artificial reality).

The wearable band 610 can also include coupling mechanism 616 (e.g., a cradle or a shape of the coupling mechanism can correspond to shape of the watch body 620 of the wrist-wearable device 600) for detachably coupling a capsule (e.g., a computing unit) or watch body 620 (via a coupling surface of the watch body 620) to the wearable band 610. In particular, the coupling mechanism 616 can be configured to receive a coupling surface proximate to the bottom side of the watch body 620 (e.g., a side opposite to a front side of the watch body 620 where the display 605 is located), such that a user can push the watch body 620 downward into the coupling mechanism 616 to attach the watch body 620 to the coupling mechanism 616. In some embodiments, the coupling mechanism 616 can be configured to receive a top side of the watch body 620 (e.g., a side proximate to the front side of the watch body 620 where the display 605 is located) that is pushed upward into the cradle, as opposed to being pushed downward into the coupling mechanism 616. In some embodiments, the coupling mechanism 616 is an integrated component of the wearable band 610 such that the wearable band 610 and the coupling mechanism 616 are a single unitary structure. In some embodiments, the coupling mechanism 616 is a type of frame or shell that allows the watch body 620 coupling surface to be retained within or on the wearable band 610 coupling mechanism 616 (e.g., a cradle, a tracker band, a support base, a clasp, etc.).

The coupling mechanism 616 can allow for the watch body 620 to be detachably coupled to the wearable band 610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 620 to the wearable band 610 and to decouple the watch body 620 from the wearable band 610. For example, a user can twist, slide, turn, push, pull, or rotate the watch body 620 relative to the wearable band 610, or a combination thereof, to attach the watch body 620 to the wearable band 610 and to detach the watch body 620 from the wearable band 610. Alternatively, as discussed below, in some embodiments, the watch body 620 can be decoupled from the wearable band 610 by actuation of the release mechanism 629.

The wearable band 610 can be coupled with a watch body 620 to increase the functionality of the wearable band 610 (e.g., converting the wearable band 610 into a wrist-wearable device 600, adding an additional computing unit and/or battery to increase computational resources and/or a battery life of the wearable band 610, adding additional sensors to improve sensed data, etc.). As described above, the wearable band 610 (and the coupling mechanism 616) is configured to operate independently (e.g., execute functions independently) from watch body 620. For example, the coupling mechanism 616 can include one or more sensors 613 that contact a user's skin when the wearable band 610 is worn by the user and provide sensor data for determining control commands.

A user can detach the watch body 620 (or capsule) from the wearable band 610 in order to reduce the encumbrance of the wrist-wearable device 600 to the user. For embodiments in which the watch body 620 is removable, the watch body 620 can be referred to as a removable structure, such that in these embodiments the wrist-wearable device 600 includes a wearable portion (e.g., the wearable band 610) and a removable structure (the watch body 620).

Turning to the watch body 620, the watch body 620 can have a substantially rectangular or circular shape. The watch body 620 is configured to be worn by the user on their wrist or on another body part. More specifically, the watch body 620 is sized to be easily carried by the user, attached on a portion of the user's clothing, and/or coupled to the wearable band 610 (forming the wrist-wearable device 600). As described above, the watch body 620 can have a shape corresponding to the coupling mechanism 616 of the wearable band 610. In some embodiments, the watch body 620 includes a single release mechanism 629 or multiple release mechanisms (e.g., two release mechanisms 629 positioned on opposing sides of the watch body 620, such as spring-loaded buttons) for decoupling the watch body 620 and the wearable band 610. The release mechanism 629 can include, without limitation, a button, a knob, a plunger, a handle, a lever, a fastener, a clasp, a dial, a latch, or a combination thereof.

A user can actuate the release mechanism 629 by pushing, turning, lifting, depressing, shifting, or performing other actions on the release mechanism 629. Actuation of the release mechanism 629 can release (e.g., decouple) the watch body 620 from the coupling mechanism 616 of the wearable band 610, allowing the user to use the watch body 620 independently from wearable band 610, and vice versa. For example, decoupling the watch body 620 from the wearable band 610 can allow the user to capture images using rear-facing camera 625B. Although the coupling mechanism 616 is shown positioned at a corner of watch body 620, the release mechanism 629 can be positioned anywhere on watch body 620 that is convenient for the user to actuate. In addition, in some embodiments, the wearable band 610 can also include a respective release mechanism for decoupling the watch body 620 from the coupling mechanism 616. In some embodiments, the release mechanism 629 is optional and the watch body 620 can be decoupled from the coupling mechanism 616 as described above (e.g., via twisting, rotating, etc.).

The watch body 620 can include one or more peripheral buttons 623 and 627 for performing various operations at the watch body 620. For example, the peripheral buttons 623 and 627 can be used to turn on or wake (e.g., transition from a sleep state to an active state) the display 605, unlock the watch body 620, increase or decrease a volume, increase or decrease brightness, interact with one or more applications, interact with one or more user interfaces, etc. Additionally, or alternatively, in some embodiments, the display 605 operates as a touch screen and allows the user to provide one or more inputs for interacting with the watch body 620.

In some embodiments, the watch body 620 includes one or more sensors 621. The sensors 621 of the watch body 620 can be the same or distinct from the sensors 613 of the wearable band 610. The sensors 621 of the watch body 620 can be distributed on an inside and/or an outside surface of the watch body 620. In some embodiments, the sensors 621 are configured to contact a user's skin when the watch body 620 is worn by the user. For example, the sensors 621 can be placed on the bottom side of the watch body 620 and the coupling mechanism 616 can be a cradle with an opening that allows the bottom side of the watch body 620 to directly contact the user's skin. Alternatively, in some embodiments, the watch body 620 does not include sensors that are configured to contact the user's skin (e.g., including sensors internal and/or external to the watch body 620 that configured to sense data of the watch body 620 and the watch body 620's surrounding environment). In some embodiments, the sensors 613 are configured to track a position and/or motion of the watch body 620.

The watch body 620 and the wearable band 610 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 620 and the wearable band 610 can share data sensed by the sensors 613 and 621, as well as application—and device-specific information (e.g., active and/or available applications), output devices (e.g., display, speakers, etc.), input devices (e.g., touch screen, microphone, imaging sensors, etc.).

In some embodiments, the watch body 620 can include, without limitation, a front-facing camera 625A and/or a rear-facing camera 625B, sensors 621 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 663; FIG. 6B), a touch sensor, a sweat sensor, etc.). In some embodiments, the watch body 620 can include one or more haptic devices 676 (FIG. 6B; a vibratory haptic actuator) that is configured to provide haptic feedback (e.g., a cutaneous and/or kinesthetic sensation, etc.) to the user. The sensors 621 and/or the haptic device 676 can also be configured to operate in conjunction with multiple applications including, without limitation, health-monitoring applications, social media applications, game applications, and artificial-reality applications (e.g., the applications associated with artificial reality).

As described above, the watch body 620 and the wearable band 610, when coupled, can form the wrist-wearable device 600. When coupled, the watch body 620 and wearable band 610 operate as a single device to execute functions (operations, detections, communications, etc.) described herein. In some embodiments, each device is provided with particular instructions for performing the one or more operations of the wrist-wearable device 600. For example, in accordance with a determination that the watch body 620 does not include neuromuscular signal sensors, the wearable band 610 can include alternative instructions for performing associated instructions (e.g., providing sensed neuromuscular signal data to the watch body 620 via a different electronic device). Operations of the wrist-wearable device 600 can be performed by the watch body 620 alone or in conjunction with the wearable band 610 (e.g., via respective processors and/or hardware components) and vice versa. In some embodiments, operations of the wrist-wearable device 600, the watch body 620, and/or the wearable band 610 can be performed in conjunction with one or more processors and/or hardware components of another communicatively coupled device (e.g., the HIPD 700; FIGS. 7A-7B).

As described below with reference to the block diagram of FIG. 6B, the wearable band 610 and/or the watch body 620 can each include independent resources required to independently execute functions. For example, the wearable band 610 and/or the watch body 620 can each include a power source (e.g., a battery), a memory, data storage, a processor (e.g., a central processing unit (CPU)), communications, a light source, and/or input/output devices.

FIG. 6B shows block diagrams of a computing system 630 corresponding to the wearable band 610, and a computing system 660 corresponding to the watch body 620, according to some embodiments. A computing system of the wrist-wearable device 600 includes a combination of components of the wearable band computing system 630 and the watch body computing system 660, in accordance with some embodiments.

The watch body 620 and/or the wearable band 610 can include one or more components shown in watch body computing system 660. In some embodiments, a single integrated circuit includes all or a substantial portion of the components of the watch body computing system 660 are included in a single integrated circuit. Alternatively, in some embodiments, components of the watch body computing system 660 are included in a plurality of integrated circuits that are communicatively coupled. In some embodiments, the watch body computing system 660 is configured to couple (e.g., via a wired or wireless connection) with the wearable band computing system 630, which allows the computing systems to share components, distribute tasks, and/or perform other operations described herein (individually or as a single device).

The watch body computing system 660 can include one or more processors 679, a controller 677, a peripherals interface 661, a power system 695, and memory (e.g., a memory 680), each of which are defined above and described in more detail below.

The power system 695 can include a charger input 696, a power-management integrated circuit (PMIC) 697, and a battery 698, each are which are defined above. In some embodiments, a watch body 620 and a wearable band 610 can have respective charger inputs (e.g., charger input 696 and 657), respective batteries (e.g., battery 698 and 659), and can share power with each other (e.g., the watch body 620 can power and/or charge the wearable band 610, and vice versa). Although watch body 620 and/or the wearable band 610 can include respective charger inputs, a single charger input can charge both devices when coupled. The watch body 620 and the wearable band 610 can receive a charge using a variety of techniques. In some embodiments, the watch body 620 and the wearable band 610 can use a wired charging assembly (e.g., power cords) to receive the charge. Alternatively, or in addition, the watch body 620 and/or the wearable band 610 can be configured for wireless charging. For example, a portable charging device can be designed to mate with a portion of watch body 620 and/or wearable band 610 and wirelessly deliver usable power to a battery of watch body 620 and/or wearable band 610. The watch body 620 and the wearable band 610 can have independent power systems (e.g., power system 695 and 656) to enable each to operate independently. The watch body 620 and wearable band 610 can also share power (e.g., one can charge the other) via respective PMICs (e.g., PMICs 697 and 658) that can share power over power and ground conductors and/or over wireless charging antennas.

In some embodiments, the peripherals interface 661 can include one or more sensors 621, many of which listed below are defined above. The sensors 621 can include one or more coupling sensors 662 for detecting when the watch body 620 is coupled with another electronic device (e.g., a wearable band 610). The sensors 621 can include imaging sensors 663 (one or more of the cameras 625 and/or separate imaging sensors 663 (e.g., thermal-imaging sensors)). In some embodiments, the sensors 621 include one or more SpO2 sensors 664. In some embodiments, the sensors 621 include one or more biopotential-signal sensors (e.g., EMG sensors 665, which may be disposed on a user-facing portion of the watch body 620 and/or the wearable band 610). In some embodiments, the sensors 621 include one or more capacitive sensors 666. In some embodiments, the sensors 621 include one or more heart rate sensors 667. In some embodiments, the sensors 621 include one or more IMUs 668. In some embodiments, one or more IMUs 668 can be configured to detect movement of a user's hand or other location that the watch body 620 is placed or held.

In some embodiments, the peripherals interface 661 includes an NFC component 669, a global-position system (GPS) component 670, a long-term evolution (LTE) component 671, and/or a Wi-Fi and/or Bluetooth communication component 672. In some embodiments, the peripherals interface 661 includes one or more buttons 673 (e.g., the peripheral buttons 623 and 627 in FIG. 6A), which, when selected by a user, cause operations to be performed at the watch body 620. In some embodiments, the peripherals interface 661 includes one or more indicators, such as a light emitting diode (LED), to provide a user with visual indicators (e.g., message received, low battery, an active microphone, and/or a camera, etc.).

The watch body 620 can include at least one display 605 for displaying visual representations of information or data to the user, including user-interface elements and/or three-dimensional (3D) virtual objects. The display can also include a touch screen for inputting user inputs, such as touch gestures, swipe gestures, and the like. The watch body 620 can include at least one speaker 674 and at least one microphone 675 for providing audio signals to the user and receiving audio input from the user. The user can provide user inputs through the microphone 675 and can also receive audio output from the speaker 674 as part of a haptic event provided by the haptic controller 678. The watch body 620 can include at least one camera 625, including a front-facing camera 625A and a rear-facing camera 625B. The cameras 625 can include ultra-wide-angle cameras, wide-angle cameras, fish-eye cameras, spherical cameras, telephoto cameras, a depth-sensing cameras, or other types of cameras.

The watch body computing system 660 can include one or more haptic controllers 678 and associated componentry (e.g., haptic devices 676) for providing haptic events at the watch body 620 (e.g., a vibrating sensation or audio output in response to an event at the watch body 620). The haptic controllers 678 can communicate with one or more haptic devices 676, such as electroacoustic devices, including a speaker of the one or more speakers 674 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 678 can provide haptic events to respective haptic actuators that are capable of being sensed by a user of the watch body 620. In some embodiments, the one or more haptic controllers 678 can receive input signals from an application of the applications 682.

In some embodiments, the computer system 630 and/or the computer system 660 can include memory 680, which can be controlled by a memory controller of the one or more controllers 677 and/or one or more processors 679. In some embodiments, software components stored in the memory 680 include one or more applications 682 configured to perform operations at the watch body 620. In some embodiments, the one or more applications 682 include games, word processors, messaging applications, calling applications, web browsers, social media applications, media streaming applications, financial applications, calendars, clocks, etc. In some embodiments, software components stored in the memory 680 include one or more communication interface modules 683 as defined above. In some embodiments, software components stored in the memory 680 include one or more graphics modules 684 for rendering, encoding, and/or decoding audio and/or visual data; and one or more data management modules 685 for collecting, organizing, and/or providing access to the data 687 stored in memory 680. In some embodiments, software components stored in the memory 680 include an avatar generation module 686A, which is configured to perform the features described above in reference to FIGS. 1A-4. In some embodiments, one or more of applications 682 and/or one or more modules can work in conjunction with one another to perform various tasks at the watch body 620.

In some embodiments, software components stored in the memory 680 can include one or more operating systems 681 (e.g., a Linux-based operating system, an Android operating system, etc.). The memory 680 can also include data 687. The data 687 can include profile data 688A, sensor data 689A, media content data 690, application data 691, and avatar generation data 692A, which stores data related to the performance of the features described above in reference to FIGS. 1A-4 (e.g., one or more assets, visual representations of user intent, and/or one or more models for generating assets and/or visual representations of user intent).

It should be appreciated that the watch body computing system 660 is an example of a computing system within the watch body 620, and that the watch body 620 can have more or fewer components than shown in the watch body computing system 660, combine two or more components, and/or have a different configuration and/or arrangement of the components. The various components shown in watch body computing system 660 are implemented in hardware, software, firmware, or a combination thereof, including one or more signal processing and/or application-specific integrated circuits.

Turning to the wearable band computing system 630, one or more components that can be included in the wearable band 610 are shown. The wearable band computing system 630 can include more or fewer components than shown in the watch body computing system 660, combine two or more components, and/or have a different configuration and/or arrangement of some or all of the components. In some embodiments, all, or a substantial portion of the components of the wearable band computing system 630 are included in a single integrated circuit. Alternatively, in some embodiments, components of the wearable band computing system 630 are included in a plurality of integrated circuits that are communicatively coupled. As described above, in some embodiments, the wearable band computing system 630 is configured to couple (e.g., via a wired or wireless connection) with the watch body computing system 660, which allows the computing systems to share components, distribute tasks, and/or perform other operations described herein (individually or as a single device).

The wearable band computing system 630, similar to the watch body computing system 660, can include one or more processors 649, one or more controllers 647 (including one or more haptics controller 648), a peripherals interface 631 that can include one or more sensors 613 and other peripheral devices, power source (e.g., a power system 656), and memory (e.g., a memory 650) that includes an operating system (e.g., an operating system 651), data (e.g., data 654 including profile data 688B, sensor data 689B, avatar generation data 692B, etc.), and one or more modules (e.g., a communications interface module 652, a data management module 653, an avatar generation module 686B, etc.).

The one or more sensors 613 can be analogous to sensors 621 of the computer system 660 in light of the definitions above. For example, sensors 613 can include one or more coupling sensors 632, one or more SpO2 sensors 634, one or more EMG sensors 635, one or more capacitive sensors 636, one or more heart rate sensors 637, and one or more IMU sensors 638.

The peripherals interface 631 can also include other components analogous to those included in the peripheral interface 661 of the computer system 660, including an NFC component 639, a GPS component 640, an LTE component 641, a Wi-Fi and/or Bluetooth communication component 642, and/or one or more haptic devices 676 as described above in reference to peripherals interface 661. In some embodiments, the peripherals interface 631 includes one or more buttons 643, a display 633, a speaker 644, a microphone 645, and a camera 655. In some embodiments, the peripherals interface 631 includes one or more indicators, such as an LED.

It should be appreciated that the wearable band computing system 630 is an example of a computing system within the wearable band 610, and that the wearable band 610 can have more or fewer components than shown in the wearable band computing system 630, combine two or more components, and/or have a different configuration and/or arrangement of the components. The various components shown in wearable band computing system 630 can be implemented in one or a combination of hardware, software, and firmware, including one or more signal processing and/or application-specific integrated circuits.

The wrist-wearable device 600 with respect to FIG. 6A is an example of the wearable band 610 and the watch body 620 coupled, so the wrist-wearable device 600 will be understood to include the components shown and described for the wearable band computing system 630 and the watch body computing system 660. In some embodiments, wrist-wearable device 600 has a split architecture (e.g., a split mechanical architecture or a split electrical architecture) between the watch body 620 and the wearable band 610. In other words, all of the components shown in the wearable band computing system 630 and the watch body computing system 660 can be housed or otherwise disposed in a combined watch device 600, or within individual components of the watch body 620, wearable band 610, and/or portions thereof (e.g., a coupling mechanism 616 of the wearable band 610).

The techniques described above can be used with any device for sensing neuromuscular signals, including the arm-wearable devices of FIG. 6A-6B, but could also be used with other types of wearable devices for sensing neuromuscular signals (such as body-wearable or head-wearable devices that might have neuromuscular sensors closer to the brain or spinal column).

In some embodiments, a wrist-wearable device 600 can be used in conjunction with a head-wearable device described below (e.g., AR device 503 and VR device) and/or an HIPD 700, and the wrist-wearable device 600 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to an example handheld intermediary processing device.

### Example Handheld Intermediary Processing Devices

FIGS. 7A and 7B illustrate an example handheld intermediary processing device (HIPD) 700, in accordance with some embodiments. The HIPD 700 is an instance of the intermediary device described in reference to FIG. 4 herein, such that the HIPD 700 should be understood to have the features described with respect to any intermediary device defined above or otherwise described herein, and vice versa. The HIPD 700 can perform various functions and/or operations associated with navigating through user interfaces and selectively opening applications, as well as the functions and/or operations described above with reference to FIGS. 1A-4.

FIG. 7A shows a top view 705 and a side view 725 of the HIPD 700. The HIPD 700 is configured to communicatively couple with one or more wearable devices (or other electronic devices) associated with a user. For example, the HIPD 700 is configured to communicatively couple with a user's wrist-wearable device 600 (or components thereof, such as the watch body 620 and the wearable band 610), AR device 503, and/or VR device. The HIPD 700 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 700 can successfully be communicatively coupled with an electronic device, such as a wearable device).

The HIPD 700 can perform various functions independently and/or in conjunction with one or more wearable devices (e.g., wrist-wearable device 600, AR device 503, VR device, etc.). The HIPD 700 is configured to increase and/or improve the functionality of communicatively coupled devices, such as the wearable devices. The HIPD 700 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-4. Additionally, as will be described in more detail below, functionality and/or operations of the HIPD 700 can include, without limitation, task offloading and/or handoffs; thermals offloading and/or handoffs; 6 degrees of freedom (6DoF) raycasting and/or gaming (e.g., using imaging devices or cameras 714A and 714B, which can be used for simultaneous localization and mapping (SLAM) and/or with other image processing techniques); portable charging; messaging; image capturing via one or more imaging devices or cameras (e.g., cameras 722A and 722B); sensing user input (e.g., sensing a touch on a multi-touch input surface 702); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 700 and/or in communication between the HIPD 700 and another wearable device described herein. In some embodiments, functions can be executed on the HIPD 700 in conjunction with an AR environment. As the skilled artisan will appreciate upon reading the descriptions provided herein, the novel the HIPD 700 described herein can be used with any type of suitable AR environment.

While the HIPD 700 is communicatively coupled with a wearable device and/or other electronic device, the HIPD 700 is configured to perform one or more operations initiated at the wearable device and/or the other electronic device. In particular, one or more operations of the wearable device and/or the other electronic device can be offloaded to the HIPD 700 to be performed. The HIPD 700 performs the one or more operations of the wearable device and/or the other electronic device and provides to data corresponded to the completed operations to the wearable device and/or the other electronic device. For example, a user can initiate a video stream using AR device 503 and back-end tasks associated with performing the video stream (e.g., video rendering) can be offloaded to the HIPD 700, which the HIPD 700 performs and provides corresponding data to the AR device 503 to perform remaining front-end tasks associated with the video stream (e.g., presenting the rendered video data via a display of the AR device 503). In this way, the HIPD 700, which has more computational resources and greater thermal headroom than a wearable device, can perform computationally intensive tasks for the wearable device improving performance of an operation performed by the wearable device.

The HIPD 700 includes a multi-touch input surface 702 on a first side (e.g., a front surface) that is configured to detect one or more user inputs. In particular, the multi-touch input surface 702 can detect single tap inputs, multi-tap inputs, swipe gestures and/or inputs, force-based and/or pressure-based touch inputs, held taps, and the like. The multi-touch input surface 702 is configured to detect capacitive touch inputs and/or force (and/or pressure) touch inputs. The multi-touch input surface 702 includes a first touch-input surface 704 defined by a surface depression, and a second touch-input surface 706 defined by a substantially planar portion. The first touch-input surface 704 can be disposed adjacent to the second touch-input surface 706. In some embodiments, the first touch-input surface 704 and the second touch-input surface 706 can be different dimensions, shapes, and/or cover different portions of the multi-touch input surface 702. For example, the first touch-input surface 704 can be substantially circular and the second touch-input surface 706 is substantially rectangular. In some embodiments, the surface depression of the multi-touch input surface 702 is configured to guide user handling of the HIPD 700. In particular, the surface depression is configured such that the user holds the HIPD 700 upright when held in a single hand (e.g., such that the using imaging devices or cameras 714A and 714B are pointed toward a ceiling or the sky). Additionally, the surface depression is configured such that the user's thumb rests within the first touch-input surface 704.

In some embodiments, the different touch-input surfaces include a plurality of touch-input zones. For example, the second touch-input surface 706 includes at least a first touch-input zone 708 within a second touch-input zone 706 and a third touch-input zone 710 within the first touch-input zone 708. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 708 causes the HIPD 700 to perform a first command and a user input detected within the second touch-input zone 706 causes the HIPD 700 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 708 can be configured to detect force touch inputs (e.g., a magnitude at which the user presses down) and capacitive touch inputs, and the second touch-input zone 706 can be configured to detect capacitive touch inputs.

The HIPD 700 includes one or more sensors 751 for sensing data used in the performance of one or more operations and/or functions. For example, the HIPD 700 can include an IMU that is used in conjunction with cameras 714 for 3-dimensional object manipulation (e.g., enlarging, moving, destroying, etc. an object) in an AR or VR environment. Non-limiting examples of the sensors 751 included in the HIPD 700 include a light sensor, a magnetometer, a depth sensor, a pressure sensor, and a force sensor. Additional examples of the sensors 751 are provided below in reference to FIG. 7B.

The HIPD 700 can include one or more light indicators 712 to provide one or more notifications to the user. In some embodiments, the light indicators are LEDs or other types of illumination devices. The light indicators 712 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 704. The light indicators can be illuminated in different colors and/or patterns to provide the user with one or more notifications and/or information about the device. For example, a light indicator positioned around the first touch-input surface 704 can flash when the user receives a notification (e.g., a message), change red when the HIPD 700 is out of power, operate as a progress bar (e.g., a light ring that is closed when a task is completed (e.g., 0% to 100%)), operates as a volume indicator, etc.).

In some embodiments, the HIPD 700 includes one or more additional sensors on another surface. For example, as shown FIG. 7A, HIPD 700 includes a set of one or more sensors (e.g., sensor set 720) on an edge of the HIPD 700. The sensor set 720, when positioned on an edge of the of the HIPD 700, can be pe positioned at a predetermined tilt angle (e.g., 26 degrees), which allows the sensor set 720 to be angled toward the user when placed on a desk or other flat surface. Alternatively, in some embodiments, the sensor set 720 is positioned on a surface opposite the multi-touch input surface 702 (e.g., a back surface). The one or more sensors of the sensor set 720 are discussed in detail below.

The side view 725 of the of the HIPD 700 shows the sensor set 720 and camera 714B. The sensor set 720 includes one or more cameras 722A and 722B, a depth projector 724, an ambient light sensor 728, and a depth receiver 730. In some embodiments, the sensor set 720 includes a light indicator 726. The light indicator 726 can operate as a privacy indicator to let the user and/or those around them know that a camera and/or microphone is active. The sensor set 720 is configured to capture a user's facial expression such that the user can puppet a custom avatar (e.g., showing emotions, such as smiles, laughter, etc., on the avatar or a digital representation of the user). The sensor set 720 can be configured as a side stereo RGB system, a rear indirect Time-of-Flight (iToF) system, or a rear stereo RGB system. As the skilled artisan will appreciate upon reading the descriptions provided herein, the novel HIPD 700 described herein can use different sensor set 720 configurations and/or sensor set 720 placement.

In some embodiments, the HIPD 700 includes one or more haptic devices 771 (FIG. 7B; e.g., a vibratory haptic actuator) that are configured to provide haptic feedback (e.g., kinesthetic sensation). The sensors 751, and/or the haptic devices 771 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 700 is configured to operate without a display. However, in optional embodiments, the HIPD 700 can include a display 768 (FIG. 7B). The HIPD 700 can also income one or more optional peripheral buttons 767 (FIG. 7B). For example, the peripheral buttons 767 can be used to turn on or turn off the HIPD 700. Further, the HIPD 700 housing can be formed of polymers and/or elastomer elastomers. The HIPD 700 can be configured to have a non-slip surface to allow the HIPD 700 to be placed on a surface without requiring a user to watch over the HIPD 700. In other words, the HIPD 700 is designed such that it would not easily slide off surfaces. In some embodiments, the HIPD 700 include one or magnets to couple the HIPD 700 to another surface. This allows the user to mount the HIPD 700 to different surfaces and provide the user with greater flexibility in use of the HIPD 700.

As described above, the HIPD 700 can distribute and/or provide instructions for performing the one or more tasks at the HIPD 700 and/or a communicatively coupled device. For example, the HIPD 700 can identify one or more back-end tasks to be performed by the HIPD 700 and one or more front-end tasks to be performed by a communicatively coupled device. While the HIPD 700 is configured to offload and/or handoff tasks of a communicatively coupled device, the HIPD 700 can perform both back-end and front-end tasks (e.g., via one or more processors, such as CPU 777; FIG. 7B). The HIPD 700 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 700 can perform the above operations alone or in conjunction with a wearable device (or other communicatively coupled electronic device).

FIG. 7B shows block diagrams of a computing system 740 of the HIPD 700, in accordance with some embodiments. The HIPD 700, described in detail above, can include one or more components shown in HIPD computing system 740. The HIPD 700 will be understood to include the components shown and described below for the HIPD computing system 740. In some embodiments, all, or a substantial portion of the components of the HIPD computing system 740 are included in a single integrated circuit. Alternatively, in some embodiments, components of the HIPD computing system 740 are included in a plurality of integrated circuits that are communicatively coupled.

The HIPD computing system 740 can include a processor (e.g., a CPU 777, a GPU, and/or a CPU with integrated graphics), a controller 775, a peripherals interface 750 that includes one or more sensors 751 and other peripheral devices, a power source (e.g., a power system 795), and memory (e.g., a memory 778) that includes an operating system (e.g., an operating system 779), data (e.g., data 788), one or more applications (e.g., applications 780), and one or more modules (e.g., a communications interface module 781, a graphics module 782, a task and processing management module 783, an interoperability module 784, an AR processing module 785, a data management module 786, an avatar generation module 787, etc.). The HIPD computing system 740 further includes a power system 795 that includes a charger input and output 796, a PMIC 797, and a battery 798, all of which are defined above.

In some embodiments, the peripherals interface 750 can include one or more sensors 751. The sensors 751 can include analogous sensors to those described above in reference to FIG. 6B. For example, the sensors 751 can include imaging sensors 754, (optional) EMG sensors 756, IMUs 758, and capacitive sensors 760. In some embodiments, the sensors 751 can include one or more pressure sensor 752 for sensing pressure data, an altimeter 753 for sensing an altitude of the HIPD 700, a magnetometer 755 for sensing a magnetic field, a depth sensor 757 (or a time-of flight sensor) for determining a difference between the camera and the subject of an image, a position sensor 759 (e.g., a flexible position sensor) for sensing a relative displacement or position change of a portion of the HIPD 700, a force sensor 761 for sensing a force applied to a portion of the HIPD 700, and a light sensor 762 (e.g., an ambient light sensor) for detecting an amount of lighting. The sensors 751 can include one or more sensors not shown in FIG. 7B.

Analogous to the peripherals described above in reference to FIGS. 6B, the peripherals interface 750 can also include an NFC component 763, a GPS component 764, an LTE component 765, a Wi-Fi and/or Bluetooth communication component 766, a speaker 769, a haptic device 771, and a microphone 773. As described above in reference to FIG. 7A, the HIPD 700 can optionally include a display 768 and/or one or more buttons 767. The peripherals interface 750 can further include one or more cameras 770, touch surfaces 772, and/or one or more light emitters 774. The multi-touch input surface 702 described above in reference to FIG. 7A is an example of touch surface 772. The light emitters 774 can be one or more LEDs, lasers, etc. and can be used to project or present information to a user. For example, the light emitters 774 can include light indicators 712 and 726 described above in reference to FIG. 7A. The cameras 770 (e.g., cameras 714A, 714B, and 722 described above in FIG. 7A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 770 can be used for SLAM; 6 DoF ray casting, gaming, object manipulation, and/or other rendering; facial recognition and facial expression recognition, etc.

Similar to the watch body computing system 660 and the watch band computing system 630 described above in reference to FIG. 6B, the HIPD computing system 740 can include one or more haptic controllers 776 and associated componentry (e.g., haptic devices 771) for providing haptic events at the HIPD 700.

Memory 778 can include high-speed random-access memory and/or non-volatile memory, such as one or more magnetic disk storage devices, flash memory devices, or other non-volatile solid-state memory devices. Access to the memory 778 by other components of the HIPD 700, such as the one or more processors and the peripherals interface 750, can be controlled by a memory controller of the controllers 775.

In some embodiments, software components stored in the memory 778 include one or more operating systems 779, one or more applications 780, one or more communication interface modules 781, one or more graphics modules 782, one or more data management modules 785, which are analogous to the software components described above in reference to FIG. 6B. The software components stored in the memory 778 can also include the avatar generation module 786A (analogous with the avatar generation module 686A), which is configured to perform the features described above in reference to FIGS. 1A-4.

In some embodiments, software components stored in the memory 778 include a task and processing management module 783 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 783 uses data 788 (e.g., device data 790) to distribute the one or more front-end and/or back-end tasks based on communicatively coupled devices' computing resources, available power, thermal headroom, ongoing operations, and/or other factors. For example, the task and processing management module 783 can cause the performance of one or more back-end tasks (of an operation performed at communicatively coupled AR device 503) at the HIPD 700 in accordance with a determination that the operation is utilizing a predetermined amount (e.g., at least 70%) of computing resources available at the AR device 503.

In some embodiments, software components stored in the memory 778 include an interoperability module 784 for exchanging and utilizing information received and/or provided to distinct communicatively coupled devices. The interoperability module 784 allows for different systems, devices, and/or applications to connect and communicate in a coordinated way without user input. In some embodiments, software components stored in the memory 778 include an AR module 785 that is configured to process signals based at least on sensor data for use in an AR and/or VR environment. For example, the AR processing module 785 can be used for 3D object manipulation, gesture recognition, facial and facial expression, recognition, etc.

The memory 778 can also include data 787, including structured data. In some embodiments, the data 787 can include profile data 789, device data 789 (including device data of one or more devices communicatively coupled with the HIPD 700, such as device type, hardware, software, configurations, etc.), sensor data 791, media content data 792, application data 793, and avatar generation data 794 (analogous with avatar generation data 692A).

It should be appreciated that the HIPD computing system 740 is an example of a computing system within the HIPD 700, and that the HIPD 700 can have more or fewer components than shown in the HIPD computing system 740, combine two or more components, and/or have a different configuration and/or arrangement of the components. The various components shown in HIPD computing system 740 are implemented in hardware, software, firmware, or a combination thereof, including one or more signal processing and/or application-specific integrated circuits.

The techniques described above in FIG. 7A-7B can be used with any device used as a human-machine interface controller. In some embodiments, an HIPD 700 can be used in conjunction with one or more wearable device such as a head-wearable device (e.g., AR device 503 and VR device) and/or a wrist-wearable device 600 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by a computing device, cause the computing device to:
in response to a text field presented at a display communicatively coupled with the computing device:
determine, based on textual data presented at the display communicatively coupled with the computing device, a user intent in responding to a portion of the textual data;
generate one or more visual representations of the user intent, each visual representation including:
a representation of a user, and
an expression of the user intent performed by the representation of the user,
present the one or more visual representations of the user intent via the display communicatively coupled with the computing device; and
in response to user selection of a visual representation of the one or more visual representations, cause display of the visual representation in the text field.

2. The non-transitory computer readable storage medium of claim 1, wherein the expression of the user intent performed by the representation of the user includes a pose.

3. The non-transitory computer readable storage medium of claim 1, wherein at least one visual representation includes a background contextualizing the user intent.

4. The non-transitory computer readable storage medium of claim 1, wherein at least one visual representation includes a text overlay contextualizing the user intent.

5. The non-transitory computer readable storage medium of claim 1, wherein at least one visual representation includes a prop contextualizing the user intent.

6. The non-transitory computer readable storage medium of claim 1, wherein:
the textual data presented at the display communicatively coupled with the computing device is a text input provided by the user; and
causing the display of the visual representation in the text field includes replacing the text input with the visual representation.

7. The non-transitory computer readable storage medium of claim 1, wherein:
the textual data presented at the display communicatively coupled with the computing device is a message received from at least one other user device.

8. The non-transitory computer readable storage medium of claim 1, wherein the user intent in responding to the portion of the data includes one or more of an emotional expression, an expression of interest, participation in a moment, and social engagement.

9. The non-transitory computer readable storage medium of claim 1, wherein each visual representation of the user intent includes a degree of personalization.

10. The non-transitory computer readable storage medium of claim 9, wherein the degree of personalization is one of universal use, niche use, and personalized use.

11. The non-transitory computer readable storage medium of claim 1, wherein generating the one or more visual representations of the user intent includes, for each visual representation, arranging one or more elements of the visual representation.

12. The non-transitory computer readable storage medium of claim 1, wherein the user intent is determined, and the one or more visual representations of the user intent are generated using a machine-learning model or an artificial intelligence model.

13. The non-transitory computer readable storage medium of claim 1, wherein the one or more visual representations of the user intent are stored.

14. The non-transitory computer readable storage medium of claim 1, wherein the one or more visual representations of the user intent include a first visual representation of the user intent and a second visual representation of the user intent distinct from the first visual representation of the user intent.

15. An electronic device, comprising:
one or more displays;
one or more programs, wherein the one or more programs are stored in memory and configured to be executed by one or more processors, the one or more programs including instructions for performing:
in response to a text field presented at a display communicatively coupled with the computing device:
determining, based on textual data presented at the display communicatively coupled with the computing device, a user intent in responding to a portion of the textual data;
generating one or more visual representations of the user intent, each visual representation including:
a representation of a user, and
an expression of the user intent performed by the representation of the user,
presenting the one or more visual representations of the user intent via the display communicatively coupled with the computing device; and
in response to user selection of a visual representation of the one or more visual representations, causing display of the visual representation in the text field.

16. The electronic device of claim 15, wherein the expression of the user intent performed by the representation of the user includes a pose.

17. The electronic device of claim 15, wherein at least one visual representation includes a background contextualizing the user intent.

18. A method of operating a user device, comprising:
in response to a text field presented at a display communicatively coupled with the computing device:
determining, based on textual data presented at the display communicatively coupled with the computing device, a user intent in responding to a portion of the textual data;
generating one or more visual representations of the user intent, each visual representation including:
a representation of a user, and
an expression of the user intent performed by the representation of the user,
presenting the one or more visual representations of the user intent via the display communicatively coupled with the computing device; and
in response to user selection of a visual representation of the one or more visual representations, causing display of the visual representation in the text field.

19. The method of claim 18, wherein the expression of the user intent performed by the representation of the user includes a pose.

20. The method of claim 18, wherein at least one visual representation includes a background contextualizing the user intent.
